(19) United States
(12) Patent Application Publication
(10) Pub. No.: US 2002/0172461 A1
(43) Pub. Date: Nov. 21, 2002

(54) Apparatus and method for fabricating chiral fiber gratings

(76) Inventors: Jonathan Singer, Summit, NJ (US); Norman Chao, Brooklyn, NY (US); Victor Il?apos;ich Kopp, Flushing, NY (US); Daniel Neugroschl, Suffern, NY (US)

Correspondence Address: Edward Etkin, Esq., Suite 3C, 4804 Bedford Avenue, Brooklyn, NY, 11235, US

(21) Appl. No.: 10/099,623

(22) Filed: Mar. 14, 2002

Related U.S. Application Data
(60) Provisional application No. 60/275,787, filed on Mar. 14, 2001.
(60) Provisional application No. 60/337,916, filed on Dec. 6, 2001.

(51) Int. Cl. G02B 6/34; F27B 9/12

(52) U.S. Cl. 385/37; 432/10; 432/18

(57) ABSTRACT

An apparatus and method for fabricating fiber gratings from optical fibers by imposing constant or variable chiral refractive index modulation along an optical fiber. The refractive index modulation may be of single helix symmetry to produce a fiber grating enabling different propagation speed of signals with the same handedness as the structure with respect to signals with opposite handedness as the structure at a wavelength substantially equal to the pitch of the single helix, or of double helix symmetry to produce a chiral fiber Bragg grating. In several embodiments of the present invention the refractive index modulation is imposed by twisting and moving a specially prepared optical fiber through a heater that heats a small region of the fiber to a temperature sufficient to allow the fiber to twist in that region as it moves through the heater. Alternately, a normal optical fiber may specially prepared for use with the apparatus of the present invention at a pre-process stage prior to twisting and heating. In other embodiments of the inventive apparatus, the refractive index modulation is imposed by cuffing one or more helical groove patters into a normal optical fiber, or by wrapping a normal fiber with one or more elongated dielectric fibers of a smaller diameter than the optical fiber in one or more helical patterns. Advantageously, the fabrication of the chiral fiber grating may be monitored and the fabrication parameters automatically adjusted to ensure that the chiral fiber grating meets desired requirements.

### CROSS REFERENCE TO RELATED APPLICATIONS

This application claims priority from the commonly assigned U.S. provisional patent application Ser. No. 60/275,787 entitled “Apparatus and Method for Fabricating Helical Fiber Bragg Gratings” filed Mar. 14, 2001, and also from the commonly assigned U.S. provisional patent application Ser. No. 60/337,916 entitled “Customizable Chirped Chiral Fiber Bragg Grating” filed Dec. 5, 2001.

### FIELD OF THE INVENTION

The present invention relates generally to fiber grating type structures, and more particularly to an apparatus and method for manufacturing superior fiber gratings.

### BACKGROUND OF THE INVENTION

There are two previously known types of one-dimensional (1D) photonic band gap (PBG) structures: (1) periodic layered media, and (2) cholesteric liquid crystals (CLCs). In both of these systems the wavelength inside the medium at the center of the band gap is twice the period of the structure in question. In CLC structures, the band gap exists only for the circular polarized component of light, which has the same sense of rotation as the structure. The second circular component is unaffected by the structure. The first type of structure has been implemented in optical fibers and is known as a fiber Bragg grating (FBG). However, the second type of structure—CLCs—does not exist in the form of fibers. Fiber Bragg gratings have many applications—fiber components form the backbone of modern information and communications technologies and are suitable for a wide range of applications—for example in information processing and especially in optical fiber communication systems utilizing wavelength division multiplexing (WDM). However, FBGs based on conventional periodic structures are not easy to manufacture and suffer from a number of disadvantages. Similarly, other types of desirable fiber gratings are diffucult to fabricate using previously known techniques.

The conventional method of manufacturing fiber gratings (including FBSs) is based on photo-induced changes of the refractive index. One approach requires fine alignment of two interfering laser beams along the length of the optical fiber. Extended lengths of periodic fiber are produced by moving the fiber and re-exposing it to the interfering illumination while carefully aligning the interference pattern to be in phase with the previously written periodic modulation. The fiber core utilized in the process must be composed of specially prepared photorefractive glass, such as germanium doped silicate glass. This approach limits the length of the resulting grating and also limits the index contrast produced. Furthermore, such equipment requires perfect alignment of the interfering lasers and exact coordination of the fiber over minute distances when it is displaced prior to being exposed again to the laser interference pattern.

Another approach to fabricating fiber gratings, involves the use of a long phase mask placed in a fixed position relative to a fiber workpiece before it is exposed to the UV beam. This approach requires photosensitive glass fibers and also requires manufacture of a specific mask for each type of fiber grating produced. Furthermore, the length of the produced fiber is limited by the length of the mask unless the fiber is displaced and re-aligned with great precision. This restricts the production of fiber gratings to relatively small lengths making the manufacturing process more time consuming and expensive.

One novel approach that addressed the problems in fabrication techniques of previously known fiber gratings is disclosed in the commonly-assigned co-pending U.S. patent application entitled “Apparatus and Method for Manufacturing Chiral Fiber Bragg Gratings”. This technique involved imposing a chiral modulation of the refractive index at the core of a UV sensitive fiber utilizing one or more independent UV beams during motion and rotation of the fiber with respect to the one or more UV beams. While this technique produces superior results it requires the use of UV-sensitive fibers and is thus limited to certain applications.

Another novel technique for fabricating chiral fibers having fiber grating properties, is disclosed in the commonly-assigned co-pending U.S. patent application entitled “Apparatus and Method for Manufacturing Periodic Grating Optical Fibers”, which is hereby incorporated by reference in its entirety. This approach (hereinafter referred to as “First Twisting Technique” or “FTT”) involved twisting a heated optical preform (comprising either a single fiber or multiple adjacent fibers) to form a chiral structure having chiral fiber Bragg grating properties. While the FTT approach has many advantages over previously known approaches, there are a number of possible areas of improvement, for example in strengthening the chiral fiber after twisting, in restricting lateral vibration of the twisting fiber, and in heating the portion of the fiber being twisted. The FTT approach also did not provide for monitoring the optical properties of the fiber during fabrication and thus could not make real-time adjustments to the fabrication process. Also the FTT required specially prepared fiber preforms—for example fibers with pre-configured core cross-section shapes and in some cases specific relationships between refractive indices of the preform fiber core and cladding. Thus, in order to fabricate a chiral fiber having a desired refractive index profile, a preform fiber with specific characteristics would need to be prepared prior to fabrication of the chiral fiber. Finally, the FTS technique relied on heating the fiber while it is being twisted—it did not address fabrication of chiral fibers having the properties of fiber gratings without heating or twisting the fiber.

It would thus be desirable to provide a fabrication apparatus and method for easily, cheaply and accurately producing an optical fiber with a constant or variable periodic grating. It would also be desirable to provide a fabrication apparatus and method for automatically preparing a desirable preform having a configuration suitable for conversion into a desirable fiber grating. It would additionally be desirable to monitor the fabrication process to ensure that the fiber grating moving through the fabrication process meets predetermined desirable characteristics and to automatically adjust one or more parameters of the fabrication process if the desirable characteristics are not being met. It would further be desirable to provide an apparatus and method for manufacturing periodic grating fibers of lengths greater than can be produced with acceptable quality utilizing previously known techniques.

### BRIEF DESCRIPTION OF THE DRAWINGS

In the drawings, wherein like reference characters denote elements throughout the several views:

FIG. 1A is a schematic diagram of a preferred embodiment of a chiral fiber grating fabrication apparatus of the present invention in a pre-fabrication configuration;

FIG. 1B is a schematic diagram of the preferred embodiment of a chiral fiber grating fabrication apparatus of FIG. 1A in a post-fabrication configuration;

FIG. 2 is a schematic diagram of a first embodiment of the chiral fiber grating fabrication apparatus of FIGS. 1A-1B;

FIG. 3 is a schematic diagram of a second embodiment of the chiral fiber grating fabrication apparatus of FIGS. 1A-1B;

FIG. 4 is a schematic diagram of a third embodiment of the chiral fiber grating fabrication apparatus of FIGS. 1A-1B;

FIG. 5 is a schematic diagram of a fourth embodiment of the chiral fiber grating fabrication apparatus of FIGS. 1A-1B;

FIG. 6 is a schematic diagram of a heating module used in conjunction with the inventive fiber grating fabrication apparatus embodiments of FIGS. 1A to 5;

FIG. 7 is a schematic diagram of a fifth embodiment of a chiral fiber grating fabrication apparatus of FIGS. 1A-1B;

FIG. 8 is a schematic isometric diagram of a fiber wrapping system used with the inventive fabrication apparatus of FIG. 7;

FIG. 9 is a schematic diagram of a sixth embodiment of a chiral fiber grating fabrication apparatus of FIGS. 1A-1B;

FIG. 10 is a schematic diagram of a fiber machining system used with the inventive fabrication apparatus of FIG. 9;

FIG. 11A is a schematic diagram of a first embodiment of a pre-process module used with the inventive fiber grating fabrication apparatus embodiments of FIGS. 1A and 1B, 2, 3, 4, 5, 7, and 9;

FIG. 11B is a schematic diagram of a second embodiment of the pre-process module used with the inventive fiber grating fabrication apparatus embodiments of FIGS. 1A-5;

FIG. 11C is a schematic diagram of a third embodiment of the pre-process module used with the inventive fiber grating fabrication apparatus embodiments of FIGS. 1A-5;

FIG. 12 is a schematic diagram of a third embodiment of the post-process module used with the inventive fiber grating fabrication apparatus embodiments of FIGS. 1A and 1B, 2, 3, 4, 5, 7, and 9;

FIGS. 13A-13B are schematic diagrams of cross-section views of a first embodiment of the fiber grating structure fabricated by one of the inventive fabrication apparatus embodiments of FIGS. 1A-5;

FIG. 13C is a schematic diagram of a side view of the first embodiment of the fiber grating structure of FIGS. 13A-13B;

FIGS. 14A-14B are schematic diagrams of cross-section views of a second embodiment of the fiber grating structure fabricated by one of the inventive fabrication apparatus embodiments of FIGS. 1A-5;

FIG. 14C is a schematic diagram of a side view of the second embodiment of the fiber grating structure of FIGS. 14A-14B;

FIG. 15A is a schematic diagram of a cross-section view of a third embodiment of the fiber grating structure fabricated by one of the inventive fabrication apparatus embodiments of FIGS. 1A-5;

FIG. 15B is a schematic diagram of a side view of the third embodiment of the fiber grating structure of FIG. 15A;

FIG. 16A is a schematic diagram of a cross-section view of a fourth embodiment of the fiber grating structure fabricated by one of the inventive fabrication apparatus embodiments of FIGS. 1A-5, and FIG. 7;

FIG. 16B is a schematic diagram of a side view of the fourth embodiment of the fiber grating structure of FIG. 16A;

FIG. 17A is a schematic diagram of a cross-section view of a fifth embodiment of the fiber grating structure fabricated by one of the inventive fabrication apparatus embodiments of FIGS. 1A-5, and FIG. 9;

FIG. 17B is a schematic diagram of a side view of the fifth embodiment of the fiber grating structure of FIG. 17A;

FIG. 18A is a schematic diagram of a cross-section view of a sixth embodiment of the fiber grating structure fabricated by one of the inventive fabrication apparatus embodiments of FIGS. 1-5A, and FIG. 7;

FIG. 18B is a schematic diagram of a side view of the sixth embodiment of the fiber grating structure of FIG. 18A;

FIG. 19A is a schematic diagram of a cross-section view of a seventh embodiment of the fiber grating structure fabricated by one of the inventive fabrication apparatus embodiments of FIGS. 1A-5; and

FIG. 19B is a schematic diagram of a side view of the seventh embodiment of the fiber grating structure of FIG. 19A.

### SUMMARY OF THE INVENTION

The present invention is directed to an apparatus and method for fabricating a fiber grating (such as fiber Bragg gratings) from an optical fiber by controlled heating and twisting of the fiber, or, in alternate embodiments of the present invention, by imposing grooves on the surface of the fiber and/or by wrapping the fiber with one or more helical patterns of dielectric material having different optical properties from the optical fiber.

In summary, the inventive apparatus imposes constant or variable chiral refractive index modulation along an optical fiber to produce a chiral fiber grating having desirable parameters. The refractive index modulation may be of single helix symmetry to produce a fiber grating enabling different propagation speed of signals with the same handedness as the structure with respect to signals with opposite handedness as the structure at a wavelength substantially equal to the pitch of the single helix. The refractive index modulation may also be of double helix symmetry to produce a chiral fiber Bragg grating. The pitch and period of the produced fiber grating may be advantageously controlled and variably modulated to produce, in addition to chiral fiber Bragg gratings, chiral chirped fiber gratings, chiral apodized fiber gratings, and chiral gratings having a distributed chiral twist.

In several embodiments of the present invention, the refractive index modulation is imposed by twisting and moving a specially prepared optical fiber through a heater that heats a small region of the fiber to a temperature sufficient to allow the fiber to twist in that region as it moves through the heater. Alternately, a normal optical fiber may specially prepared for use with the apparatus of the present invention at a pre-process stage, prior to twisting and heating the fiber, for example by cutting one or more grooves into the sides of the optical fiber, or by forming the optical fiber into a new non-circular cross-sectional shape having 180 degree cross-sectional symmetry.

The pre-process stage may also include a device for feeding the optical fiber into the inventive apparatus and then cutting the fiber once it has been secure for fabrication of the chiral fiber grating therefrom. Advantageously the pre-process stage may be automated to feed additional optical fibers into the fabrication apparatus after a previously fed optical fiber has been formed into a chiral fiber grating.

The inventive apparatus may also include a post process stage for adjusting fiber gratings that did not satisfy the fabrication requirements, for collecting formed fiber gratings, for applying one or more cladding layers (if necessary) to the chiral fiber grating, and for optionally annealing the fiber grating to reduce stress in the fiber induced by the fabrication process.

In other embodiments of the inventive apparatus, the refractive index modulation is imposed by cutting one or more helical groove patters into a normal optical fiber, or by wrapping a normal fiber with one or more elongated dielectric fibers of a smaller diameter than the optical fiber in one or more helical patterns.

An optional control system controls the operation of the various components of the inventive apparatus. Advantageously, the fabrication of the chiral fiber grating may be monitored by a monitoring system connected to the control system, and the fabrication parameters automatically adjusted by the control system to ensure that the chiral fiber grating meets desired requirements. Optionally, the monitoring system may indicate that a fiber grating that did not meet the desired requirements be subjected to the fabrication process once again so that necessary adjustments may be made.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENT

The present invention is directed to an apparatus and method for imposing constant or variable chiral refractive index modulation along an optical fiber to produce a chiral fiber grating having desirable parameters. The refractive index modulation may be of single helix symmetry to produce a fiber grating enabling different propagation speed of signals with the same handedness as the structure with respect to signals with opposite handedness as the structure at a wavelength substantially equal to the pitch of the single helix. The refractive index modulation may also be of double helix symmetry to produce a chiral fiber Bragg grating. The pitch and period of the produced fiber grating may be advantageously controlled and variably modulated to produce, in addition to chiral fiber Bragg gratings, chiral chirped fiber gratings, chiral apodized fiber gratings, and chiral gratings having a distributed chiral twist.

Prior to discussing the various embodiments of the inventive apparatus, it would be helpful to describe the principles of one dimensional (“1D”) periodic structures having a photonic band gap. In addition to periodic layered structures, another type of photonic band gap 1D structures is known—cholesteric liquid crystals (CLCs). In all layered periodic systems, and CLC systems, the wavelength inside the medium at the center of the band gap is twice the period of the structure. In CLC structures, the band gap exists only for the circular polarized component of light, which has the same sense of rotation as the structure. The second circular component is unaffected by the structure.

Because CLCs exhibit superior properties in comparison to layered media (as disclosed in commonly assigned co-pending U.S. patent application entitled “Chiral Laser Apparatus and Method”), it would be advantageous to implement the essence of a cholesteric periodic photonic band gap (hereinafter “PBG”) structure in an optical fiber. This approach captures the superior optical properties of CLCs while facilitating the manufacture of the structure as a continuous (and thus easier to implement) process.

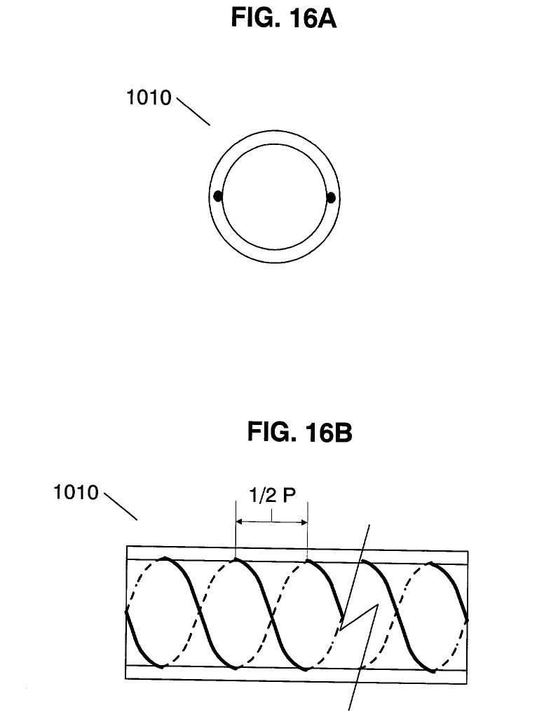

In order to accomplish this, the inventive structure must mimic the essence of a conventional CLC structure—its longitudinal symmetry. A helical fiber structure appears to have the desired properties. However, in a CLC structure the pitch of the structure is twice its period. This is distinct from the simplest realization of the helical structure, which is a single helix. In the single helix structure, the period is equal to the pitch and one would expect to find the band gap centered at the wavelength equal to twice the pitch. However, this arrangement produces a mismatch between the orientation of the electric field of light passing through the structure and the symmetry of the helix. The field becomes rotated by 360 degrees at a distance equal to the wavelength of light of twice the pitch. On the other hand, the helix rotation in this distance is 720 degrees. Thus, while a fiber grating based on a single helix structure has certain beneficial applications, it does not truly mimic the desirable CLC structure, although such a structure still provides significant benefits in certain applications as discussed below in connection with FIGS. 16A-19B.

In accordance with the present invention, a structure that meets the requirements for producing a photonic stop band, while preserving the advantages of a cholesteric structure, must satisfy one crucial requirement: that the pitch of the structure is twice the period. If this requirement is met in a structure then the photonic band gap will be created for radiation propagating through the structure that satisfies the following requirements:

(1) the radiation must be circularly polarized with the same handedness as the structure;

(2) the radiation must propagate along the longitudinal axis of the structure; and

(3) the wavelength of the radiation inside the structure must be approximately equal to the pitch of the structure.

The inventive structure that advantageously satisfies the requirement that its pitch be twice its period, has a double helix configuration, where two identical coaxial helixes are imposed in or on a fiber structure, and where the second helix is shifted by half of the structure's pitch forward from the first helix.

Several embodiments of such advantageous double and single helix structures in optical fibers are disclosed in the commonly assigned co-pending U.S. patent application entitled “Chiral Fiber Grating” which is incorporated by reference herein in its entirety.

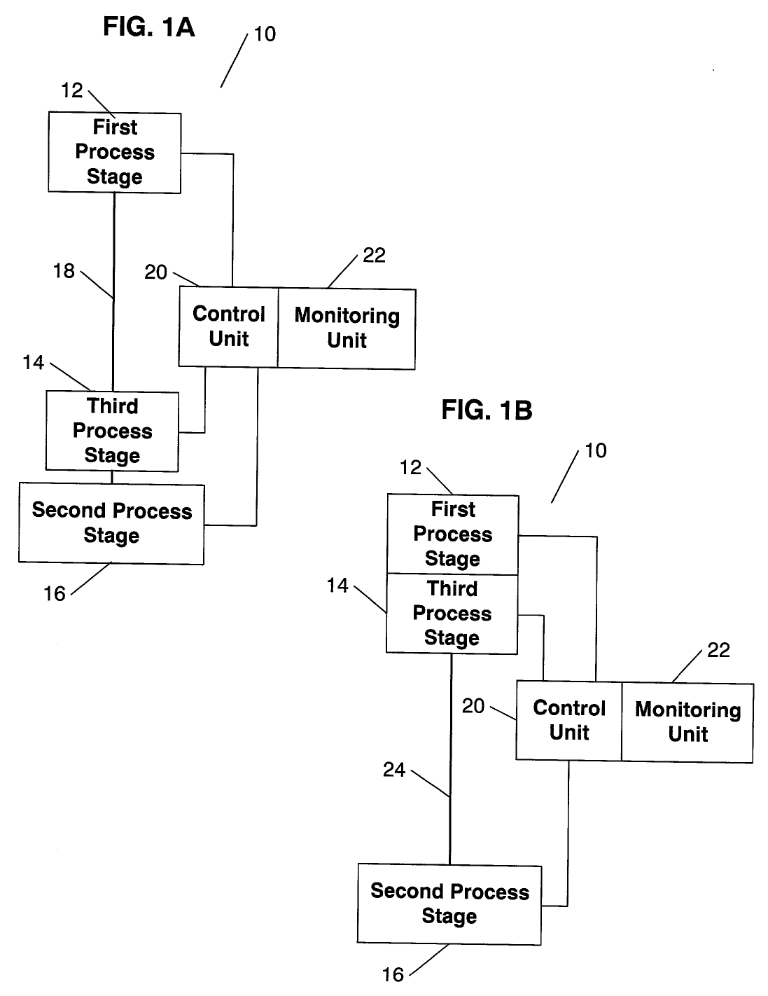

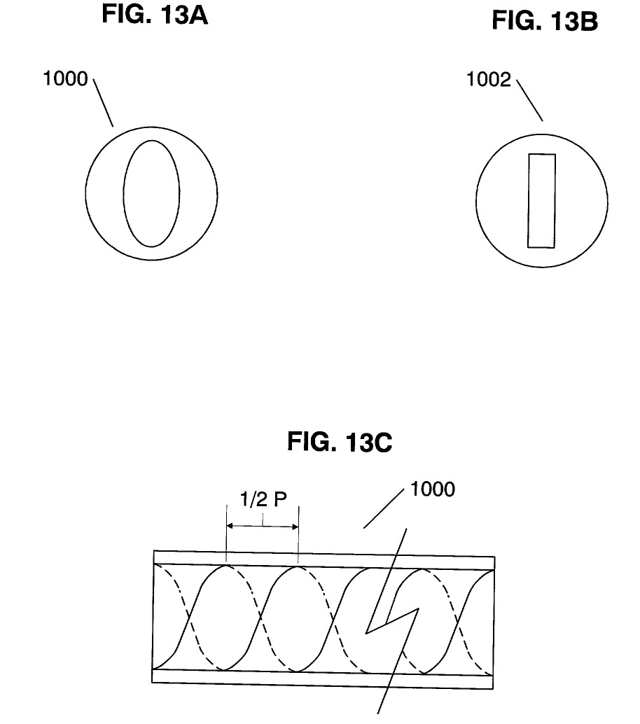

Referring now to FIGS. 1A-12, the various embodiments of the inventive fiber grating fabrication apparatus and additional components thereof may be operated to advantageously produce the various optical fiber gratings shown in FIGS. 13A-19B as well as chirped fiber gratings (not shown), apodized fiber gratings (not shown) that are disclosed in the commonly assigned co-pending U.S. provisional patent application entitled “Apodized Chiral Fiber Grating” which is incorporated by reference herein in its entirety, and distributed twist chiral fiber gratings (not shown) that are disclosed in the commonly assigned co-pending U.S. provisional patent application entitled “Distributed Twist Chiral Fiber Grating” which is incorporated by reference herein in its entirety.

It should be noted that certain components of the inventive apparatus may be similar to components utilized in the FTT apparatus of the above-incorporated “Apparatus and Method for Manufacturing Periodic Grating Optical Fibers” patent application. Such similar components may readily be adapted for use with the various embodiments of the fabrication apparatus of the present invention as a matter of design choice. Furthermore, certain components referred to in the various embodiments of the inventive fabrication apparatus of FIGS. 1A-12, such as holding units, twisting devices, feeding units, linear translation stages, and the like, may be known in the art and thus do not need to be described in great detail.

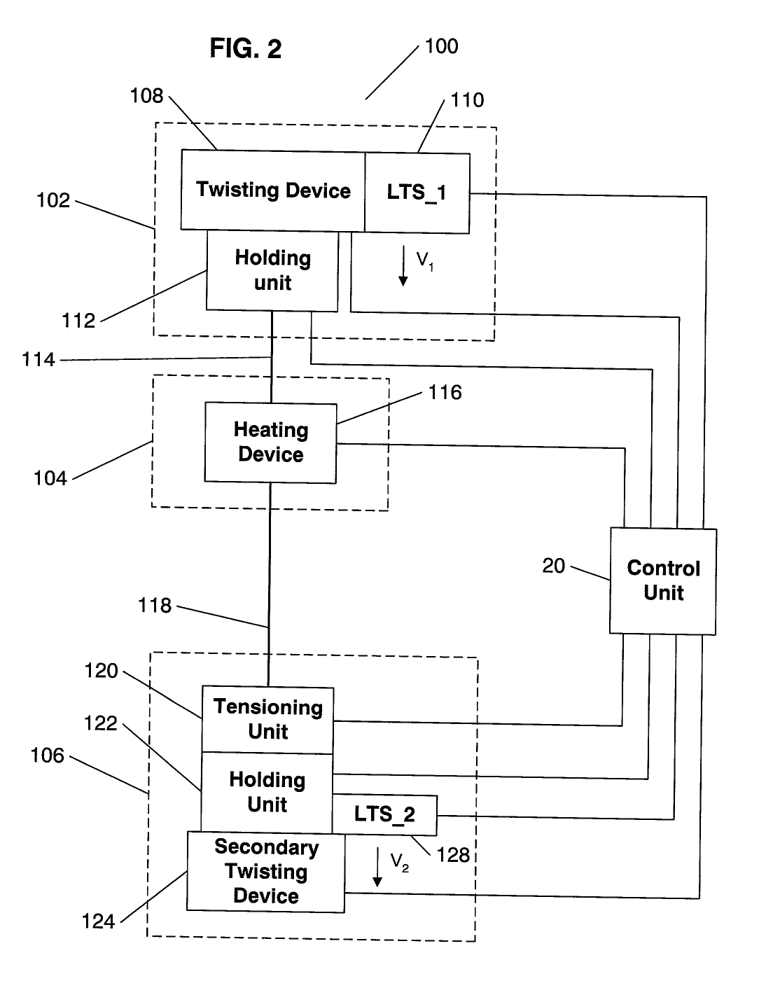

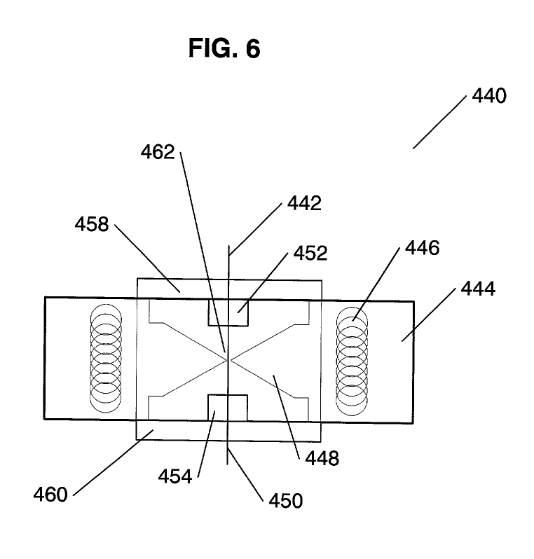

Because the inventive apparatus is modular and configurable in a variety of arrangements with a number of optional modules, FIGS. 1A and 1B show basic principles of operation of the inventive apparatus, FIGS. 2-5, 7 and 9 show the various exemplary embodiments of the inventive apparatus, FIGS. 6, 8, and 10 show exemplary components that may be utilized in one or more of the embodiments of the inventive apparatus shown in FIGS. 2-5, 7 and 9, and FIGS. 11A-12 show various embodiments of additional modules that may be utilized in conjunction with one or more of the various embodiments of the inventive apparatus shown in FIGS. 2-5, 7 and 9.

Referring now to FIGS. 1A and 1B, a preferred embodiment of the inventive fiber grating fabrication apparatus is shown as a fabrication apparatus 10. The fabrication apparatus 10 includes a first stage 12 for securing one end of an optical fiber 18, a second stage 16 for securing the other end of the optical fiber 18, and a third process stage 14, disposed between the first process stage 12 and the second process stage 16 for imposing the desired refractive index modulation on the optical fiber 18, while the fiber 18 is rotated by at least one of the first and second process stages 12, 16 as the fiber 18 moves through the third process stage 14 by linear movement of one or more of the process stages 12, 14, 16 with respect to one another.

Preferably, the third process stage 14 includes a restriction device (not shown) for restricting lateral vibration or motion of the optical fiber 18 (and the fiber grating 24) during operation of the fabrication apparatus 10. Optionally, at least one of the first and second process stages 12, 16 may also incorporate similar restriction devices (not shown). Alternately, similar restriction devices may be positioned independently between the first and second process stages 12, 16.

An optional control unit 20, such as a microprocessor, computer or a solid state control system, may be connected to the process stages, 12, 14, 16 to control the operation thereof. Optionally, the control unit 20 may consist of one or more control modules (not shown), each for independently controlling one or more of the process stages 12, 14, 16. FIG. 1A shows the fabrication apparatus 10 in a pre-fabrication configuration, where the fiber 18 has not yet moved through the third process stage 14. FIG. 1B shows the fabrication apparatus 10 in a post-fabrication configuration where the fiber 18 has substantially moved through the third process stage 14 and the desired refractive index modulation has been imposed on a substantial portion of the fiber 18 to form a fiber grating 24.

An optional monitoring unit 22 may be connected to the control unit 20 for monitoring the optical characteristics of the fiber grating 24 during the fabrication process to ensure that the fiber grating 24 being produced is meeting predetermined fabrication requirements (i.e. refractive index modulation characteristics, fiber grating strength modulation, grating diameter, and other characteristics). If the predetermined fabrication requirements are not being met, the monitoring unit 22 may cause the control unit 20 to change one or more operational characteristics (individual and relative rotational or linear speed and acceleration, process temperature, etc.) of the process stages 12, 14, 16 until the produced fiber grating 24 meets these requirements. The monitoring unit 22 may monitor the fiber grating 24 from one of the fiber's sides or along its central longitudinal axis. Optionally, if the monitoring unit 22 determines that the fiber grating 24 did not meet the predetermined fabrication requirements after the conclusion of the fabrication process, the fiber grating 24 can be subjected to the fabrication process once more so that necessary adjustments may be made.

The control unit 20 provides complete control over the refractive index modulation imposed on the optical fiber 18 to form the fiber grating 24. Accordingly, chiral fiber gratings of a wide variety of desirable configurations and properties may be formed as a matter of design choice in accordance with the present invention as described in the following Examples 1-5. It should be noted that the various embodiments of the fabrication apparatus 10 shown in FIGS. 2-5, 7 and 9 can be readily utilized to fabricate one or more fiber grating described in the following examples.

### EXAMPLE 1

### Chiral Fiber Grating

In this example, the control unit 20 causes a single helix refractive index modulation to be imposed on the optical fiber 18 which results in a fiber grating enabling different propagation speed of signals with the same handedness as the structure with respect to signals with opposite handedness as the structure at a wavelength substantially equal to the pitch of the single helix which in turn results in rotation of the polarization plane of linearly polarized light. Such a fiber grating is particularly useful in add-drop filers, such as ones disclosed in co-pending commonly assigned U.S. patent application entitled “Add-Drop Filter Utilizing Chiral Elements” and the co-pending commonly assigned U.S. provisional patent application entitled “Configurable Add-Drop Filter Utilizing Resonant Optical Activity”.

### EXAMPLE 2

### Chiral Fiber Bragg Grating

In this example, the control unit 20 causes a double helix refractive index modulation to be imposed on the optical fiber 18 which results in a fiber Bragg grating with a photonic Bang gap. Such a fiber Bragg grating is advantageous for a number of applications such as lasers, sensors and filters. Chiral fiber Bragg gratings are particularly useful in applications disclosed in the following commonly assigned U.S. provisional patent applications entitled “Chiral Fiber Laser Apparatus and Method”, “Chiral in-Fiber Adjustable Polarizer Apparatus and Method”, and “Chiral Fiber Sensor Apparatus and Method”.

### EXAMPLE 3

### Chirped chiral fiber grating

In this example, the control unit 20 causes a refractive index modulation with a varying period to be imposed on the optical fiber 18 which results in a chirped chiral fiber grating having a period that varies along its central longitudinal axis. Chirped chiral fiber gratings, described in greater detail in the commonly assigned U.S. provisional patent application entitled “Customizable Chirped Chiral Fiber Bragg Grating” are useful in a variety of applications, such as in chromatic dispersion compensators. The varying period of the chirped chiral fiber grating can be achieved by selective control, by the control system 20, of at least one of twisting speed and acceleration and linear speed and acceleration of the optical fiber 18 during the fabrication process.

### EXAMPLE 4

### Apodized Chiral Fiber Grating

In this example, the control unit 20 causes increasing grating strength to be imposed in a first section of the optical fiber 18, a constant grating strength modulation to be defined in a sequential second section of the optical fiber 18, and decreasing grating strength to be defined in a sequential third section of the optical fiber 18. This change of the strength of the grating results in an apodized chiral fiber grating described in greater detail in the commonly assigned co-pending U.S. provisional patent application entitled “Customizable Apodized Chiral Fiber Grating”. The change of the grating strength of the apodized chiral fiber grating can be linear, sinusoidal, or co-sinusoidal and may be achieved by selective control, by the control system 20, of at least one of twisting speed and acceleration and linear speed and acceleration of the optical fiber 18 during the fabrication process.

### EXAMPLE 5

### Distributed Chiral Twist Fiber Grating

In this example, the control unit 20 causes refractive index modulation to be different between two sections of the chiral fiber grating 24 such that the grating has a first section of a first pitch, a second section of a second pitch, and a third section of the first pitch, where the second section comprises a gradual chiral twist of a predetermined angle between the first and third sections thereby forming a distributed chiral twist fiber grating. The distributed chiral twist fiber grating is advantageous over a standard chiral twist structure (disclosed in a commonly assigned co-pending U.S. Patent application entitled “Chiral Twist Laser and Filter Apparatus and Method”) in that there is a wider energy distribution inside a distributed chiral twist fiber grating doped with an active material. The distributed chiral twist fiber grating is described in greater detail in the commonly assigned co-pending U.S. provisional patent application entitled “Distributed Twist Chiral Fiber Grating”. The change in the pitch along the chiral fiber grating and the predetermined angle can be achieved by selective control, by the control system 20, of at least one of twisting speed and acceleration and linear speed and acceleration of the optical fiber 18 during the fabrication process.

Referring now to FIG. 2, a first embodiment of the fabrication apparatus 10 of FIGS. 1A and 1B is shown as a fabrication apparatus 100. The fabrication apparatus includes a first process stage 102, corresponding to the first process stage 12 of FIGS. 1A, 1B, a second process stage 106, corresponding to the second process stage 16 of FIGS. 1A, 1B, and a third process stage 104, corresponding to the third process stage 14 of FIGS. 1A, 1B. The fabrication apparatus 100 is shown during the fabrication process where an unprocessed optical fiber section 114 is shown above the process stage 104, and the processed chiral fiber grating 118 is shown below the process stage 104. It should be noted that prior to the fabrication process the chiral fiber grating 118 is not yet formed and thus the optical fiber 114 extends through the third process stage 104 and into the second process stage 106 (not shown).

The first process stage 102 includes a holding unit 112, such as a chuck, for securely retaining the first end of the optical fiber 114, and a twisting device 108, such as a motor, connected to the holding unit 112 for twisting the first end of the fiber 114 in a predetermined first direction at a first predetermined twisting speed and acceleration. Optionally, the twisting device 108 and the holding unit 112 may be combined in a single device (not shown) for retaining and twisting the first end of the fiber 114. The twisting device 108 is mounted on a linear translation stage 110 for linear movement at a first predefined linear speed and acceleration V₁ along a predefined linear path, such that when the linear translation stage 110 is activated, the first end of the fiber 114 is moved along the linear path at linear speed and acceleration V₁.

The second process stage 106 includes a tensioning unit 120 for providing constant tension to the second end of the optical fiber 114 (and eventually the second end of the formed fiber grating 118 after the fabrication process has begun), a holding unit 122, such as a chuck, for securely retaining the second end of the optical fiber 114. The holding unit 122 is mounted on a linear translation stage 128 for linear movement at a second predefined linear speed and acceleration V₂ along the predefined linear path, such that when the linear translation stage 128 is activated, the second end of the fiber 114 is moved along the linear path at the linear speed and acceleration V₂. An optional secondary twisting device 124 may be connected to the holding unit 122 for twisting the second end of the fiber in an opposite radial direction from the first end of the fiber twisted by the twisting device 108. This arrangement accelerates the fiber grating fabrication process. Alternately, the tensioning unit 120 may be eliminated and necessary tension may be provided by positioning of the holding unit 122 with respect to the holding unit 112 through the respective linear translation stages 110 and 128.

The third stage 104 includes a heater 116, which preferably restricts heat delivery to a very small area of the optical fiber 114 passing therethrough. The heat is delivered to the small area at a process temperature sufficient to cause the fiber 114 to be susceptible to twisting. Preferably, the small area is restricted such that heat is delivered only to the immediate area being twisted. The heater 116 preferably includes active and/or passive insulation devices for restricting propagation of heat along the optical fiber 114 and the chiral fiber grating 118 outside the small area. An advantageous exemplary configuration of the heater 116 is shown in FIG. 6 and is described below in connection therewith.

Optionally, one or more of the twisting devices 108, 124, holding units 112,122, linear translation stages 110, 128, the tensioning unit 120 and the heating device 116, may be connected to the control unit 20 for selective automatic control thereof.

During operation of the fabrication apparatus 100, the fiber 114 is moved through the heater 116 while being twisted by the twisting device 108 (and optionally also by the secondary twisting device 124). When the linear speeds V₁ and V₂ are equal, the diameter of the produced fiber grating 118 is substantially similar to the optical fiber 114. However, when the linear speed V₂ is greater than V₁, the diameter of the produced fiber grating 118 is smaller than the optical fiber 114, because the fiber grating 118 is essentially drawn out of the heater 116.

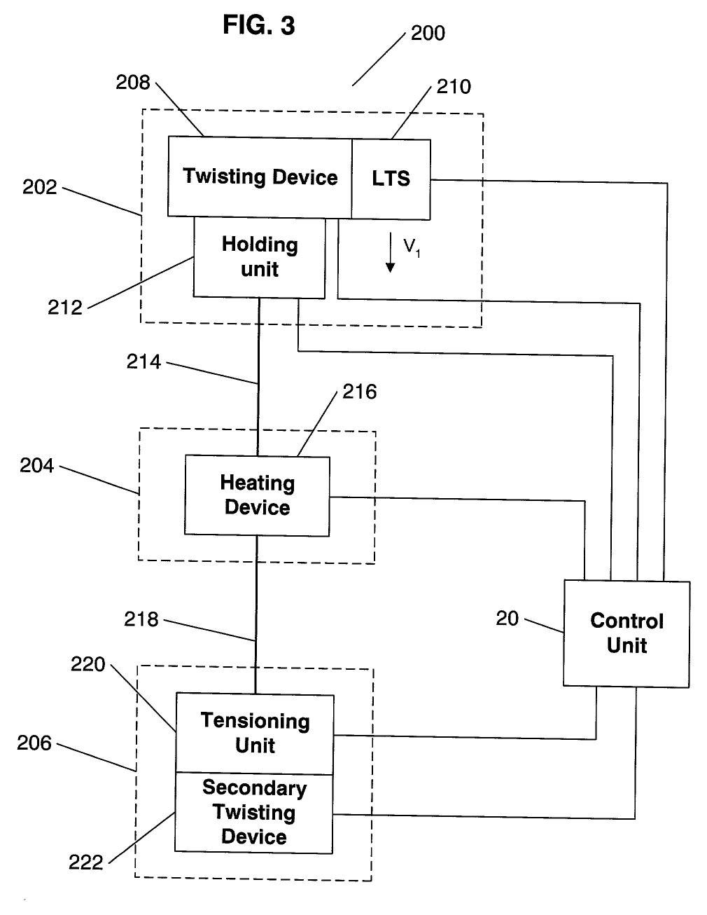

Referring now to FIG. 3, a second embodiment of the fabrication apparatus 10 of FIGS. 1A and 1B is shown as a fabrication apparatus 200. The fabrication apparatus includes a first process stage 202, corresponding to the first process stage 12 of FIGS. 1A, 1B, and substantially similar to the first process stage 102 of FIG. 2, a third stage 206, corresponding to the second process stage 16 of FIGS. 1A, 1B, and a third process stage 204, corresponding to the third process stage 14 of FIGS. 1A, 1B, and substantially similar to the third process stage 104 of FIG. 2. The fabrication apparatus 200 is shown during the fabrication process where an unprocessed optical fiber section 214 is shown above the process stage 204, and the processed chiral fiber grating 218 is shown below the process stage 204. It should be noted that prior to the fabrication process the chiral fiber grating 218 is not yet formed and thus the optical fiber 214 extends through the third process stage 204 and into the second process stage 206 (not shown).

The first process stage 202 includes a holding unit 212, such as a chuck, for securely retaining the first end of the optical fiber 214, and a twisting device 208, such as a motor, connected to the holding unit 212 for twisting the first end of the fiber 214 in a predetermined first direction at a first predetermined twisting speed and acceleration. Optionally, the twisting device 208 and the holding unit 212 may be combined in a single device (not shown) for retaining and twisting the first end of the fiber 214. The twisting device 208 is mounted on a linear translation stage 210 for linear movement at a first predefined linear speed and acceleration V₁ along a predefined linear path, such that when the linear translation stage 210 is activated, the first end of the fiber 214 is moved along the linear path at linear speed and acceleration V₁.

The second process stage 206 includes a tensioning unit 220 for providing constant tension to the second end of the optical fiber 214 (and eventually the second end of the formed fiber grating 218 after the fabrication process has begun) and for securely retaining the second end of the optical fiber 214. An optional secondary twisting device 222 may be connected to the tensioning unit 220 for twisting the second end of the fiber 214 in an opposite radial direction from the first end of the fiber twisted by the twisting device 208. This arrangement accelerates the fiber grating fabrication process.

The third stage 204 includes a heater 216, which is identical to the heater 116 described in connection with FIG. 2 above. An advantageous exemplary configuration of the heater 216 is shown in FIG. 6 and is described below in connection therewith.

Optionally, one or more of the twisting devices 208, 222, the holding unit 212, the linear translation stage 210, the tensioning unit 220 and the heating device 216, may be connected to the control unit 20 for selective automatic control thereof.

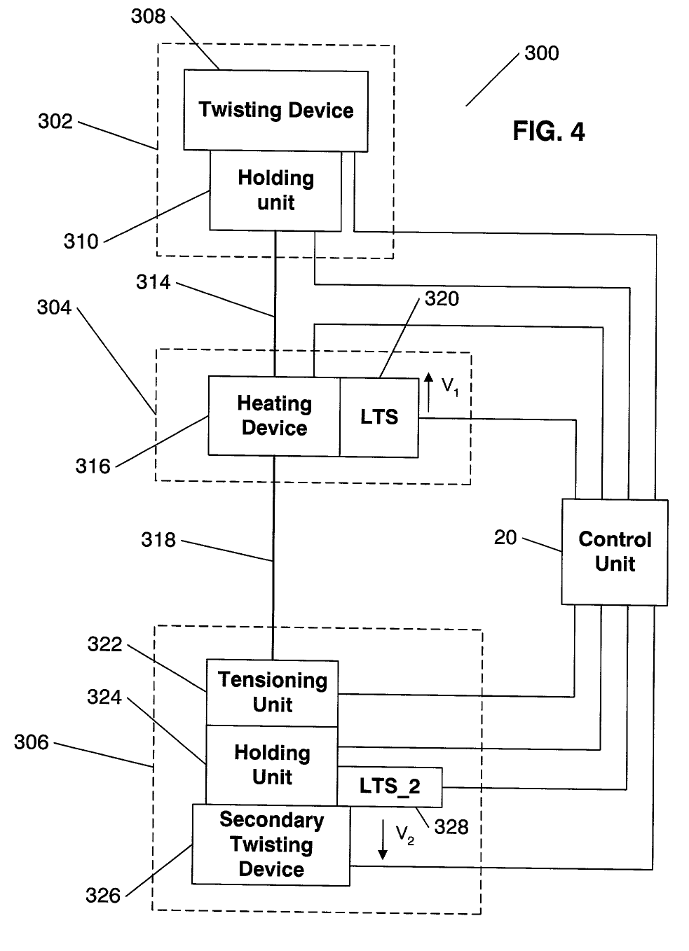

Referring now to FIG. 4, a third embodiment of the fabrication apparatus 10 of FIGS. 1A and 1B is shown as a fabrication apparatus 300. The fabrication apparatus includes a first process stage 302, corresponding to the first process stage 12 of FIGS. 1A, 1B, a second process stage 306, corresponding to the second process stage 16 of FIGS. 1A, 1B, and substantially similar to the second process stage 106 of FIG. 2, and a third process stage 304, corresponding to the third process stage 14 of FIGS. 1A, 1B. The fabrication apparatus 300 is shown during the fabrication process where an unprocessed optical fiber section 314 is shown above the process stage 304, and the processed chiral fiber grating 318 is shown below the process stage 304. It should be noted that prior to the fabrication process, the chiral fiber grating 318 is not yet formed and thus the optical fiber 314 extends through the third process stage 304 and into the second process stage 306 (not shown).

The first process stage 302 includes a holding unit 310 and a twisting device 308 that are substantially similar in operation to the twisting device 108 and the holding device 112 of FIG. 2. Unlike the first process stage 102 of FIG. 2, the first process stage 302 is stationary.

The second process stage 306 includes a tensioning unit 322, a holding unit 324, an optional linear translation stage 328, and an optional secondary twisting device 326 that are substantially similar in operation to the corresponding tensioning unit 120, holding unit 122, linear translation stage 128, and secondary twisting device 124 of FIG. 2.

The third process stage 304 includes a heater 316, which is identical to the heater 116 described in connection with FIG. 2 above. An advantageous exemplary configuration of the heater 316 is shown in FIG. 6 and is described below in connection therewith. The third process stage 304 also includes a linear translation stage 320 for providing linear motion to the third process stage 304 along the optical fiber 318 at a linear speed and acceleration V₁ (which may be in either linear direction as a matter of design choice). During operation of the fabrication apparatus 300, the linear translation stage 328 may be activated to move at a speed and acceleration V₂ which provides a drawing force on the fiber grating 318 to reduce its diameter.

Optionally, one or more of the twisting devices 308, 326, holding units 310, 324, linear translation stages 320, 328, the tensioning unit 322 and the heating device 316, may be connected to the control unit 20 for selective automatic control thereof.

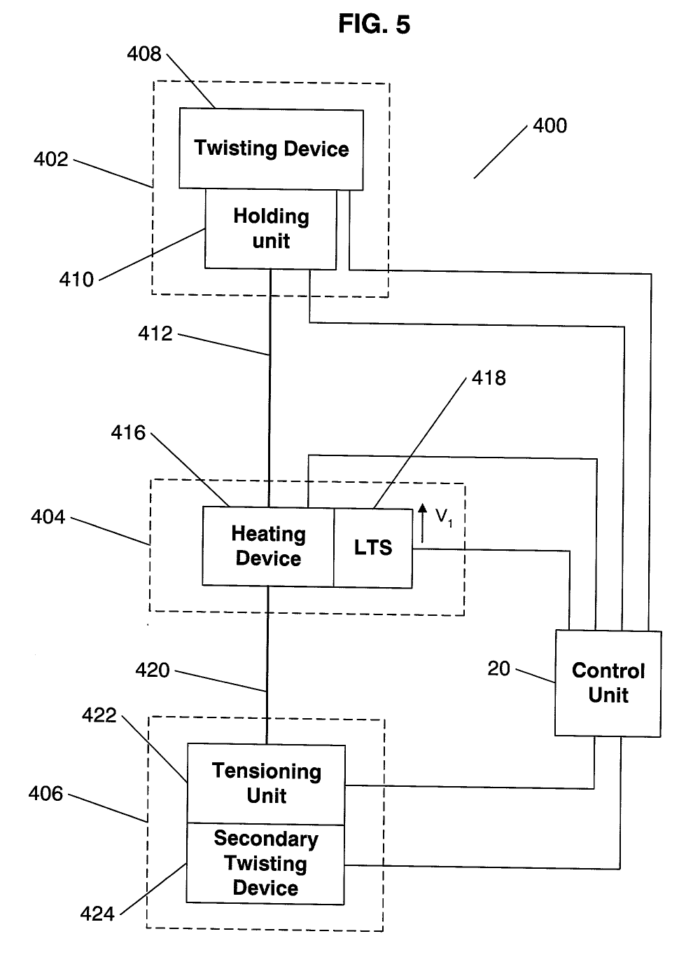

Referring now to FIG. 5, a fourth embodiment of the fabrication apparatus 10 of FIGS. 1A and 1B is shown as a fabrication apparatus 400. The fabrication apparatus includes a first process stage 402, corresponding to the first process stage 12 of FIGS. 1A, 1B and substantially similar to the first process stage 302 of FIG. 4, a second process stage 406, corresponding to the second process stage 16 of FIGS. 1A, 1B and substantially similar to the second process stage 206 of FIG. 3, and a third process stage 404, corresponding to the third process stage 14 of FIGS. 1A, 1B and substantially similar to the third process stage 304 of FIG. 4. The fabrication apparatus 400 is shown during the fabrication process where an unprocessed optical fiber section 412 is shown above the process stage 404, and the processed chiral fiber grating 420 is shown below the process stage 404. It should be noted that prior to the fabrication process, the chiral fiber grating 420 is not yet formed and thus the optical fiber 412 extends through the third process stage 404 and into the second process stage 406 (not shown).

The first process stage 402 includes a holding unit 410 and a twisting device 408 that are substantially similar in operation to the twisting device 308 and the holding unit 310 of FIG. 4.

The second process stage 406 includes a tensioning unit 422 incorporating a holding unit and an optional secondary twisting device 424 that are substantially similar in operation to the corresponding tensioning unit 220 and secondary twisting device 222 of FIG. 3.

The third process stage 404 includes a heater 416, which is identical to the heater 116 described in connection with FIG. 2 above. An advantageous exemplary configuration of the heater 416 is shown in FIG. 6 and is described below in connection therewith. The third process stage 404 also includes a linear translation stage 418 that is substantially similar in operation to the corresponding linear translation stage 320 of FIG. 4.

Optionally, one or more of the twisting devices 408, 424, the holding unit 410, the linear translation stage 418, the tensioning unit 422 and the heating device 416, may be connected to the control unit 20 for selective automatic control thereof.

Referring now to FIG. 6, an exemplary embodiment of a heater 440 is shown. The heater 440 may be advantageously utilized in the various fabrication apparatus embodiments of FIGS. 1A-5. An optical fiber 442 passes through the heater 440 and exits as a chiral fiber grating 450 (assuming that the optical fiber 442 is twisted about its longitudinal axis as it is moved linearly through the heater 440).

The heater 440 includes a housing 444 surrounding the optical fiber 442, a heating source 446 (such as a heating coil) also disposed around the fiber 442, and a conductor device 448 in proximal contact with the heating source 446, and radially surrounding at least a portion of the optical fiber 442, for transmitting heat from the heat source 446 only to a small twisting area 462, such that the optical fiber 442 is heated to the process temperature only in that area. The conductor device 448 may be a single unit such as a full or a partial ring around the fiber 442, or it may be a collection of several conductors radially disposed around the fiber 442.

Optional restrictive devices 452, 454, such as narrow insulated apertures in the heater housing 444, may be disposed above and below the twisting area 462 to restrict lateral vibration of the fiber 442 and to restrict propagation of heat along the fiber 442 along and the fiber grating 450 outside of the twisting area 462. Restriction of heat propagation may be assisted by optional active (e.g. air or fluid) and/or passive (insulation) cooling units 458 and 460 disposed above and or below the twisting area 462.

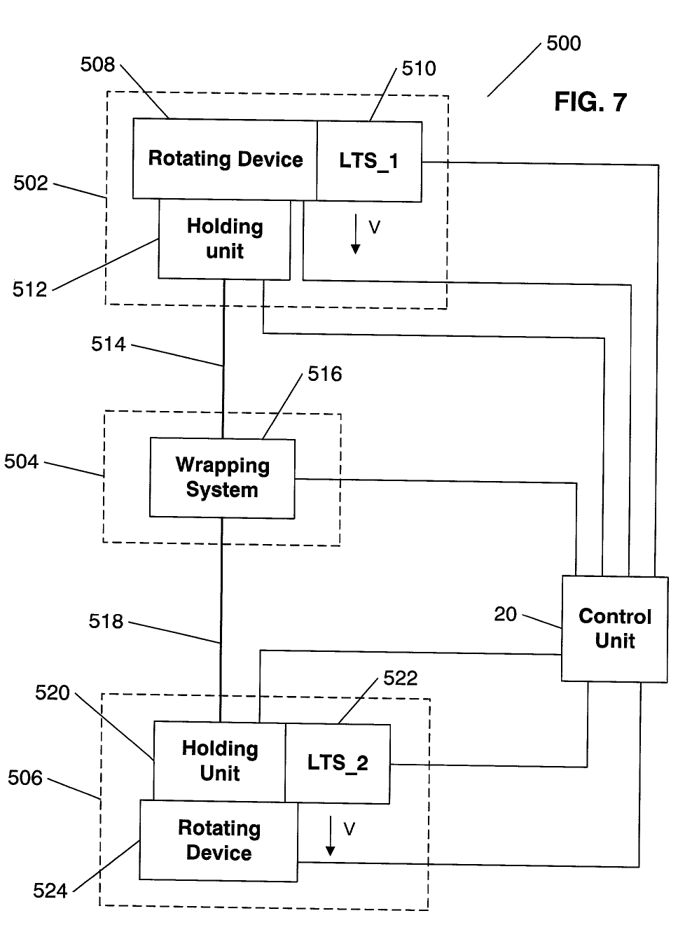

Referring now to FIG. 7, a fifth embodiment of the fabrication apparatus 10 of FIGS. 1A and 1B is shown as a fabrication apparatus 500. The fabrication apparatus 500 includes a first process stage 502, corresponding to the first process stage 12 of FIGS. 1A, 1B, a second process stage 506, corresponding to the second process stage 16 of FIGS. 1A, 1B, and a third process stage 504, corresponding to the third process stage 14 of FIGS. 1A, 1B. The fabrication apparatus 500 is shown during the fabrication process where an unprocessed optical fiber section 514 is shown above the process stage 504, and the processed chiral fiber grating 518 is shown below the process stage 504. It should be noted that prior to the fabrication process the chiral fiber grating 518 is not yet formed and thus the optical fiber 514 extends through the third process stage 504 and into the second process stage 506 (not shown).

The first process stage 502 includes a holding unit 512, such as a chuck, for securely retaining the first end of the optical fiber 514, and a rotating device 508, such as a motor, connected to the holding unit 512 for rotating the first end of the fiber 514 in a predetermined direction at a predetermined twisting speed and acceleration. Optionally, the rotating device 508 and the holding unit 512 may be combined in a single device (not shown) for retaining and rotating the first end of the fiber 514. The rotating device 508 is mounted on a linear translation stage 510 for linear movement at a predefined linear speed and acceleration V along a predefined linear path, such that when the linear translation stage 510 is activated, the first end of the fiber 514 is moved along the linear path at linear speed and acceleration V.

The second process stage 506 includes a holding unit 520, such as a chuck, for securely retaining the second end of the optical fiber 514. The holding unit 520 is mounted on a linear translation stage 522 for linear movement at the predefined linear speed and acceleration V along the predefined linear path, such that when the linear translation stage 522 is activated, the second end of the fiber 514 is also moved along the linear path at the linear speed and acceleration V. A secondary rotating device 524 is connected to the holding unit 520 for rotating the second end of the fiber in the same radial direction as the first end of the fiber rotated by the rotating device 508. Desired tension (for example to reduce lateral vibration) may be provided to the optical fiber 514 by slightly moving the holding unit 512 with respect to the holding unit 520 through the respective linear translation stages 510 and 522.

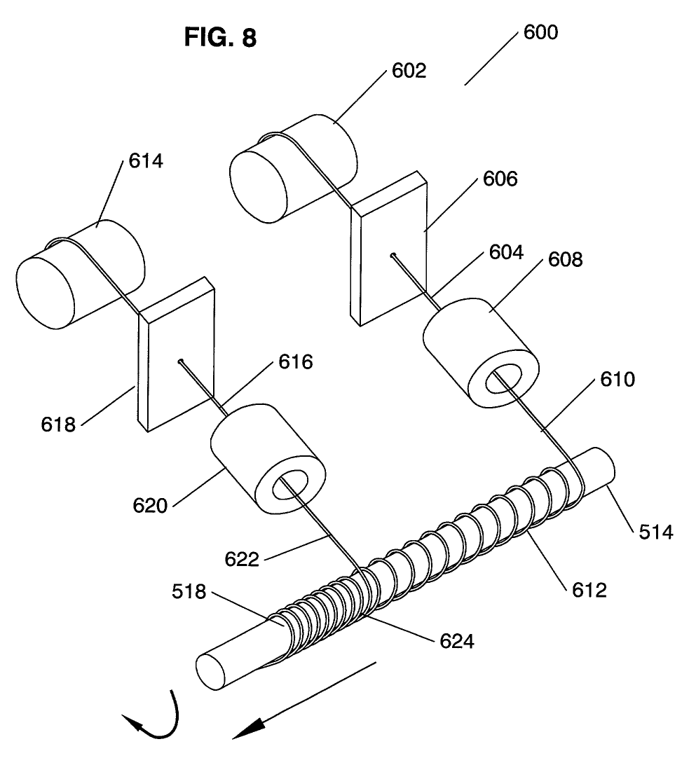

The third stage 504 includes a wrapping system 516 for wrapping one or more elongated dielectric members, having a diameter smaller than that of the optical fiber 514, and being composed of a material with different optical properties from the optical fiber 514, to form one or more helical patterns along the optical fiber 514. The dielectric members may be wrapped around a commonly used optical fiber or around a specially prepared optical fiber having one or more helical grooves inscribed in its surface shaped and configured to receive the one or more dielectric members. An advantageous exemplary configuration of the wrapping system 516 is shown in FIG. 8 and is described below in connection therewith. During operation of the fabrication apparatus 500 the fiber 514 is moved through the wrapping system 516 while the fiber 514 is being rotated by the rotating devices 508, 524.

Optionally, one or more of the rotating devices 508, 524, holding units 512, 520, linear translation stages 510, 522, and the wrapping system 516, may be connected to the control unit 20 for selective automatic control thereof.

Referring now to FIG. 8, an exemplary embodiment of a wrapping system 600 is shown. The optical fiber 514 passes through the wrapping system 600 and exits as the chiral fiber grating 518 (assuming that the optical fiber 514 is rotated about its longitudinal axis as it is moved linearly through the wrapping system 600). The wrapping system 600 includes a first coil 602 with an elongated dielectric member 604 coiled thereon, that is fed through a stabilizing unit 606, for restricting lateral movement of the member 604 during the wrapping process, and then through a heater 608 to heat the member 604 to a sufficient temperature to enable twisting of the member 604 around the optical fiber 514 (this is shown as heated member 610). As the optical fiber 514 passes through the wrapping system 600, a first helical pattern 612 is deposited on its surface (or into a surface groove, if present) at a predefined pitch. This forms a chiral fiber grating 518 with single helix symmetry. If double helix symmetry is desired (for example for a chiral fiber Bragg grating), then the wrapping system 600 is provided with a second coil 614 with an second elongated dielectric member 616 coiled thereon, that is fed through a second stabilizing unit 618, for restricting lateral movement of the member 616 during the wrapping process, and then through a heater 620 to heat the member 616 to a sufficient temperature to enable twisting of the member around the optical fiber 514 (this is shown as heated member 622). As the optical fiber 514 passes through the wrapping system 600, a second helical pattern 624 is deposited on its surface (or into a surface groove, if present) offset by a distance of approximately one half of the predefined pitch from the first helical pattern 612 thereby forming a chiral fiber grating 518 with double helix symmetry.

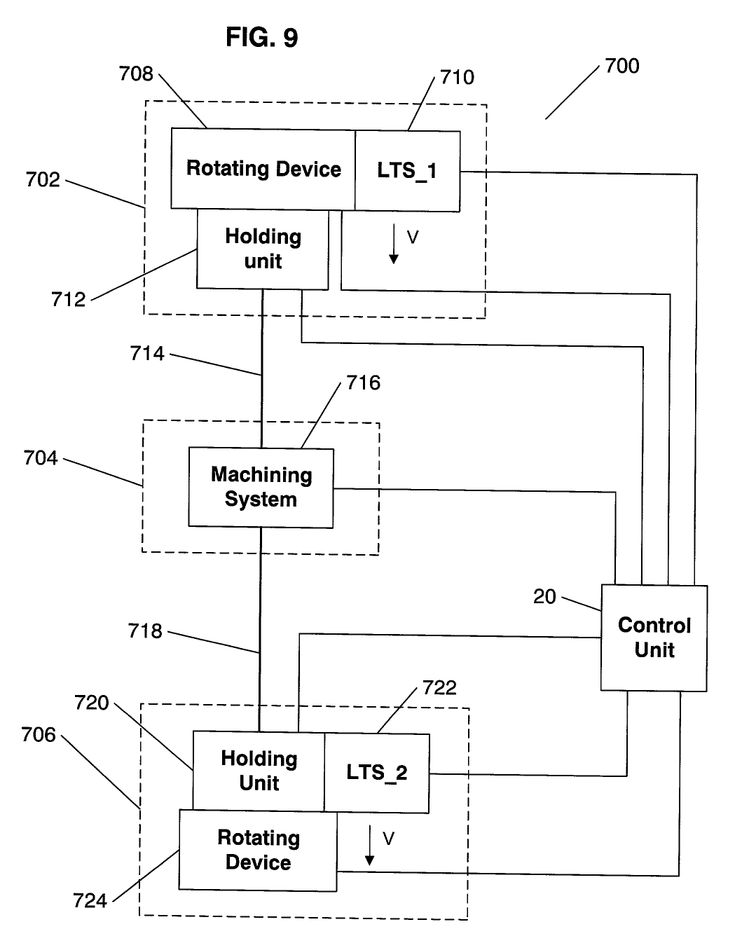

Referring now to FIG. 9, a sixth embodiment of the fabrication apparatus 10 of FIGS. 1A and 1B is shown as a fabrication apparatus 700 that is substantially similar in construction and operation to the fabrication apparatus 500 of FIG. 7 except that the wrapping system 516 of FIG. 7 is replaced by a machining system 716. The fabrication apparatus 700 includes a first process stage 702, corresponding to the first process stage 12 of FIGS. 1A, 1B, a second process stage 706, corresponding to the second process stage 16 of FIGS. 1A, 1B, and a third process stage 704, corresponding to the third process stage 14 of FIGS. 1A, 1B. The fabrication apparatus 700 is shown during the fabrication process where an unprocessed optical fiber section 714 is shown above the process stage 704, and the processed chiral fiber grating 718 is shown below the process stage 704. It should be noted that prior to the fabrication process the chiral fiber grating 718 is not yet formed and thus the optical fiber 714 extends through the third process stage 704 and into the second process stage 706 (not shown).

The first process stage 702 includes a holding unit 712, a rotating device 708, and a linear translation stage 710 that are substantially similar in construction and operation to respective holding unit 512, rotating device 508, and linear translation stage 510 of FIG. 7.

The second process stage 706 includes a holding unit 720, a rotating device 724, and a linear translation stage 722 that are substantially similar in construction and operation to respective holding unit 520, rotating device 524, and linear translation stage 522 of FIG. 7.

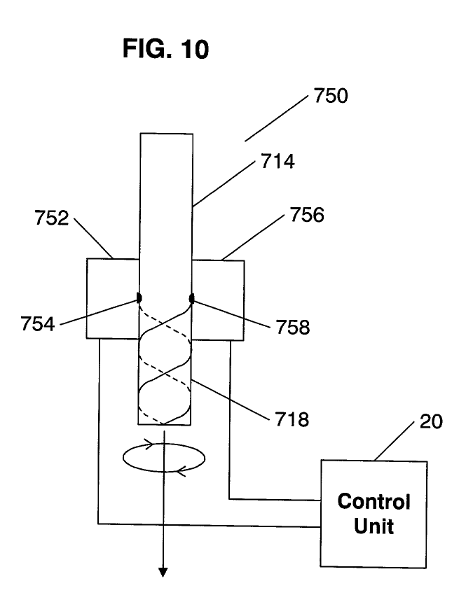

The third stage 704 includes a machining system 716 for inscribing one or more helical groove patterns in the outer surface and along the longitudinal axis of the optical fiber 714. An advantageous exemplary configuration of the machining system 716 is shown in FIG. 10 and is described below in connection therewith. During operation of the fabrication apparatus 700, the fiber 714 is moved through the machining system 716 while the fiber 714 is being rotated by the rotating devices 708, 724.

Optionally, one or more of the rotating devices 708, 724, holding units 712, 720, linear translation stages 710, 722, and the machining system 716, may be connected to the control unit 20 for selective automatic control thereof.

Referring now to FIG. 10, an exemplary embodiment of a machining system 750 is shown. The optical fiber 714 passes through the machining system 750 and exits as the chiral fiber grating 718 (assuming that the optical fiber 714 is rotated about its longitudinal axis as it is moved linearly through the machining system 750). The machining system 750 includes a machining unit 752 for inscribing a helical groove pattern 754 of a predefined pitch in the surface of the optical fiber 714 to produce a chiral fiber grating 718 with single helix symmetry. If double helix symmetry is desired (for example for a chiral fiber Bragg grating), then the machining system 750 is provided with a second optional machining unit 756, positioned opposite to the machining unit 752 on the other side of the fiber 714, for inscribing a second helical groove pattern 758 of the predefined pitch in the surface of the optical fiber 714, offset by a distance of approximately one half of the predefined pitch from the first helical pattern 754, thereby forming a chiral fiber grating 718 with double helix symmetry. The machining units 752, 756 may be connected to the control unit 20 to enable independent control of their operation.

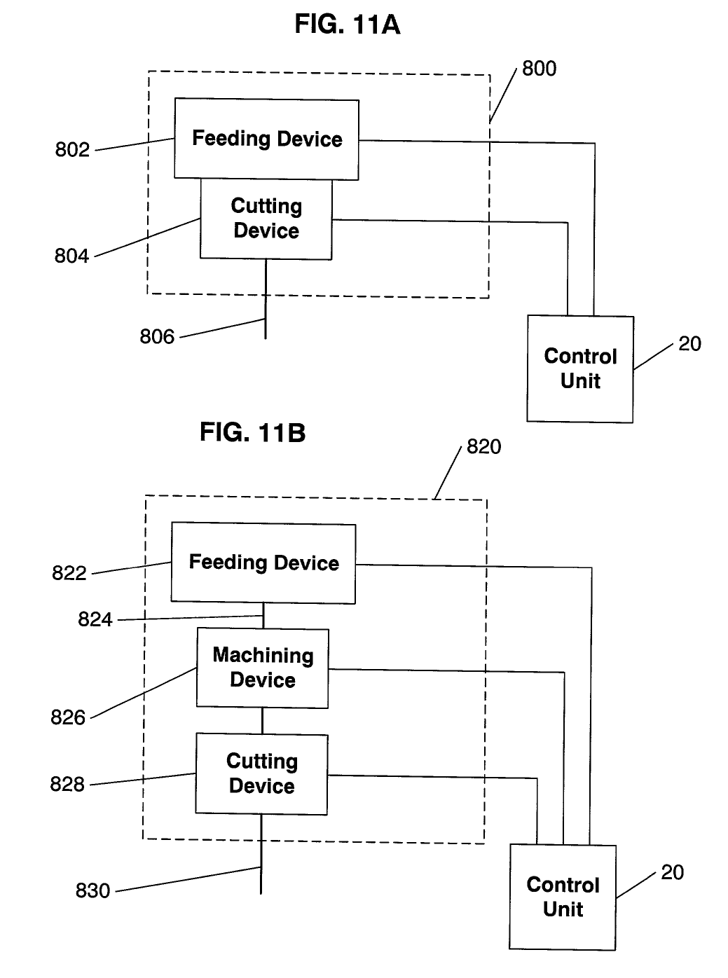

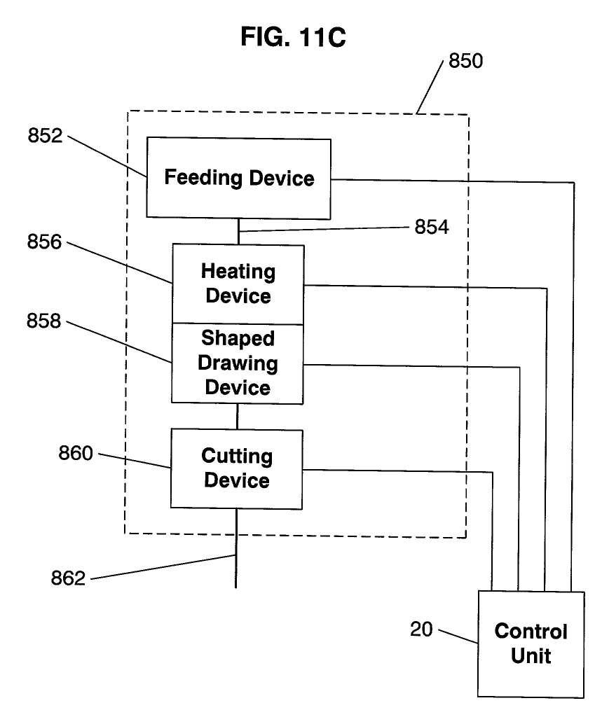

Referring now to FIGS. 11A-11C, several embodiments of optional preprocess stages are shown. The pre-process stages may be advantageously utilized in conjunction with one or more embodiments of the fabrication apparatus 10 of FIGS. 1A-1B.

Referring now to FIG. 11A, a first embodiment of a pre-process stage is shown as a pre-process stage 800. The pre-process stage 800 is preferably positioned above the first process stage 12, and includes a feeding device 802, such as a coil with an optical fiber thereon, for feeding the optical fiber 806 through the process stages 12, 14, 16, and a cutting device 804 for cutting the optical fiber 806 above the first process stage 12, subsequent to feeding of the fiber 806, but prior to initiation of the fabrication process. The pre-process stage 800 is advantageous when the optical fiber 806 is a specially prepared optical fiber suitable for twisting, or when an ordinary optical fiber is modified by the fabrication apparatus such as the case with fabrication apparatus 500 of FIG. 7, and fabrication apparatus 700 of FIG. 9. Optionally, one or both of the feeding device 802 and the cutting device 804 may be connected to the control unit 20, for selective control thereof. For example, the control unit 20 may run a continuous fabrication process by causing the feeding unit to automatically feed a new optical fiber into the fabrication apparatus 10, after a previous chiral fiber grating or produced.

Referring now to FIG. 11B, a second embodiment of a pre-process stage is shown as a pre-process stage 820. The pre-process stage 820 is preferably positioned above the first process stage 12, and includes a feeding device 822, such as a coil with an optical fiber thereon, for feeding the optical fiber 824 through a machining device 826 that forms an ordinary optical fiber into a specially prepared fiber workpiece 830, and then feeding the workpiece 830 through the process stages 12, 14, 16. The pre-process stage 820 also includes a cutting device 828 for cutting the fiber workpiece 830 above the first process stage 12, subsequent to feeding of the workpiece 830, but prior to initiation of the fabrication process. The machining device 826 may cut one or more linear grooves into the sides of the fiber 824 or may utilize an ablation technique to change the cross section of the fiber 824 to have non-circular 180 degree cross-sectional symmetry. The pre-process stage 820 is advantageous when the optical fiber 824 is an ordinary fiber that will be used with embodiments of the fabrication apparatus of FIGS. 2-5.

Referring now to FIG. 11C, a third embodiment of a pre-process stage is shown as a pre-process stage 850. The pre-process stage 850 is preferably positioned above the first process stage 12, and includes a feeding device 852, such as a coil with an optical fiber thereon, for feeding the optical fiber 854 through a heating device 856 and a shaped drawing device 858 that together form an ordinary optical fiber into a specially prepared fiber workpiece 862, and then feeding the workpiece 862 through the process stages 12, 14, 16. The pre-process stage 850 also includes a cutting device 860 for cutting the fiber workpiece 862 above the first process stage 12, subsequent to feeding of the workpiece 862, but prior to initiation of the fabrication process. The heating device 856 heats the fiber 854 to a sufficient temperature to make the fiber 854 susceptible to drawing, while the shaped drawing device 858 draws the fiber therethrough to change the cross section of the fiber 854 to have non-circular 180 degree cross-sectional symmetry. Optionally, the heating device 856 and the shaped drawing device 858 are connected to the control unit 20 for selective control thereof. The pre-process stage 850 is advantageous when the optical fiber 854 is an ordinary fiber that will be used with embodiments of the fabrication apparatus of FIGS. 2-5.

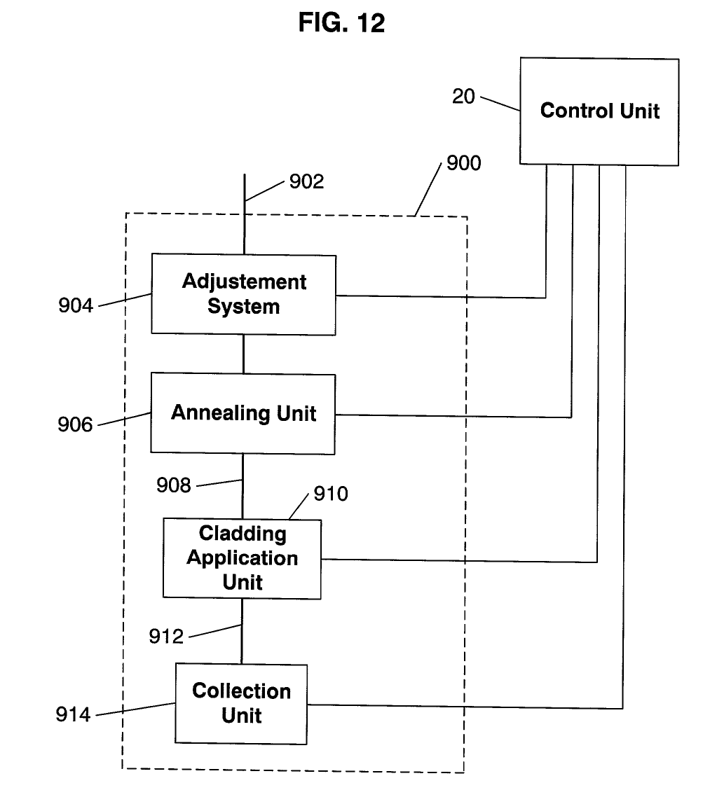

Referring now to FIG. 12, an optional post-process stage 900 is shown. The post-process stage 900 may be advantageously utilized in conjunction with one or more embodiments of the fabrication apparatus 10 of FIGS. 1A-1B. The post-process stage 900 receives a fully formed chiral fiber grating 902 from the second process stage 16 of FIG. 1 and passes it through an optional adjustment system 904, an optional annealing unit 906, an optional cladding application unit 910, into an optional collection unit 914.

The adjustment system 904 is connected to the control system 20 and the monitoring unit 22 and is capable of making additional changes to the characteristics of the fiber grating 902 such as adding additional twisting or modifying the fiber length by heating and drawing it. If the monitoring unit 22 determines that the fiber grating 902 does not meet the predetermined fabrication requirements after the conclusion of the fabrication process, the fiber grating 902 can be adjusted by the adjustment system 904. This arrangement is particularly useful if the fiber grating 902 is a chirped or apodized grating and needs minor adjustments after fabrication. This advantageous ability to modify a fiber grating after fabrication, is in stark contrast with prior art fiber grating fabrication systems where a fabricated fiber grating cannot be altered.

The annealing unit 906 heats the chiral fiber grating 902 to a predetermined annealing temperature, and then allows it to slowly cool down to produce a strengthened chiral fiber grating 908. This process reduces stress in the chiral fiber grating 902 that may have been caused by the fabrication process.

If the chiral fiber grating 902 was formed from a bare optical fiber core (rather than a optical fiber with cladding), then the optional cladding application unit applies one or more layers of cladding (for example cladding and supercladding) to the chiral fiber grating to form a clad chiral fiber grating 912. The collection unit 914 collects and stores chiral fiber gratings produced by the fabrication apparatus 10. The collection unit 914 is particularly useful if the fabrication apparatus 10 is supplied with an automated pre-process stage (such as any of the pre-process stages shown in FIGS. 11A-11C) and configured for continuous fabrication. Optionally, at least one of the annealing unit 906, the cladding application unit 910 and the collection unit 916 are connected to the control unit 20 for selective control thereof.

Referring now to FIGS. 13A-19B, a number of exemplary optical fiber grating structures that may be fabricated by operation of one or more embodiments of the fabrication apparatus of FIGS. 1A-1B, are shown. It should be noted that the exemplary optical fiber grating structures of FIGS. 13A-19B are shown by way of example only and that other fiber grating structures, such as chirped, apodized and distributed chiral twist fiber gratings (not shown) may be fabricated by one or more embodiments of the fabrication apparatus of FIGS. 1A-1B as a matter of design choice without departing from the spirit of the invention. While the exemplary optical fiber grating structures of FIGS. 13A-19B are shown with cladding materials, it should be noted that they can be readily fabricated as bare cores and one or more cladding layers applied after fabrication.

Referring now to FIGS. 13A-13C, chiral fibers 1000 and 1002 each have fiber cores composed of a single material but have non-circular cross-sections with 180 degree cross-sectional symmetry. Because of this configuration, when the fiber 1000 or 1002 are twisted, a double helix structure is formed. The exact cross sectional shape of the optical fibers 1000, 1002 may be selected from a variety of non-circular geometric shapes as long as 180 degree cross-sectional symmetry is maintained.

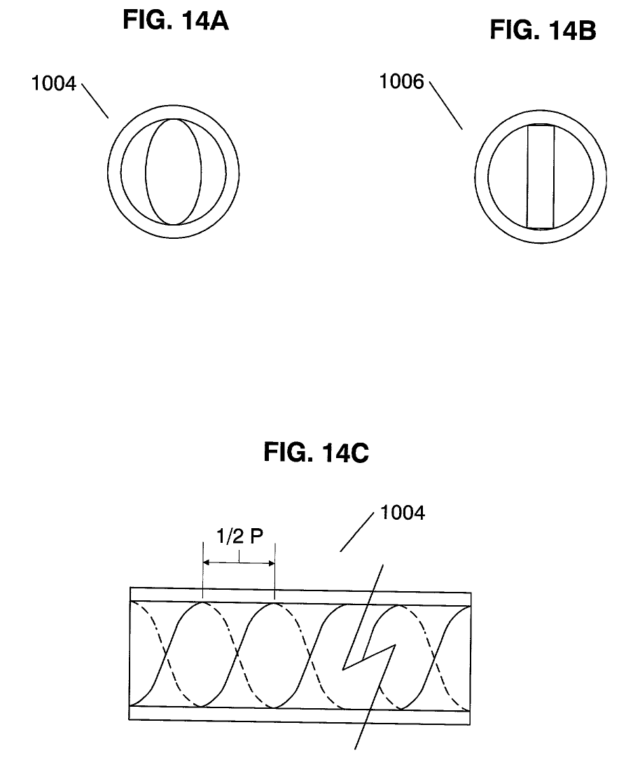

Referring now to FIGS. 14A-14C, chiral fibers 1004 and 1006 each have fiber cores composed of a single material but have non-circular cross-sections with 180 degree cross-sectional symmetry. Because of this configuration, when the fiber 1004 or 1006 is twisted, a double helix structure is formed. The exact cross sectional shape of the optical fibers 1004, 1006 may be selected from a variety of non-circular geometric shapes as long as 180 degree cross-sectional symmetry is maintained. Each of the chiral fibers 1004, 1006 includes hollow cylindrical cladding either surrounding or in contact with the core, where the empty space between the inner surface of the cladding and the core is filled with a different material from the core. The different material may be any air or any dielectric material having different optical properties from the core.

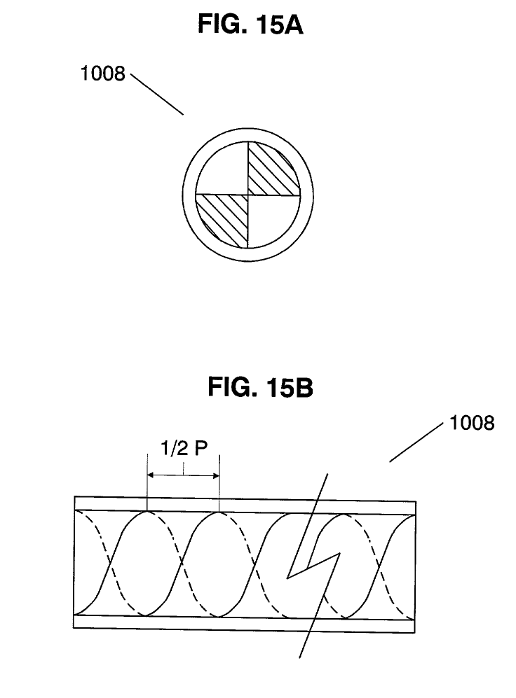

Referring now to FIGS. 15A-15B, a chiral fiber 1008 is composed of a first quarter-cylindrical portion of a first material in contact on each side with a second and third quarter cylindrical portions composed of a second material, and a fourth quarter-cylindrical portion of the first material contacting its sides with the second and third quarter cylindrical portion sides that are not in contact with the first quarter-cylindrical portion; where all vertices of the first, second, third and fourth quarter-cylindrical portions are aligned with the central longitudinal axis of the optical fiber. Each of the first and second materials have different optical properties. The fiber 1008 is twisted around its longitudinal axis so that a double helix structure along the length of the fiber is formed from the two different materials. The specific materials used may be selected as a matter of design choice without departing from the spirit of the invention.

Referring now to FIGS. 16A-16B, a chiral fiber 1010 includes first and second helices of the desired double helix structure that are formed by wrapping elongated members composed of a dielectric material, having different optical properties from the material of the chiral fiber core, around the outside surface of the core to form two sequential helical patterns. The composition of the elongated members may be selected as a matter of design choice without departing from the spirit of the invention. It should be noted that only a single helical pattern may be formed, as a matter of design choice, to produce a fiber grating with a single helix symmetry (not shown).

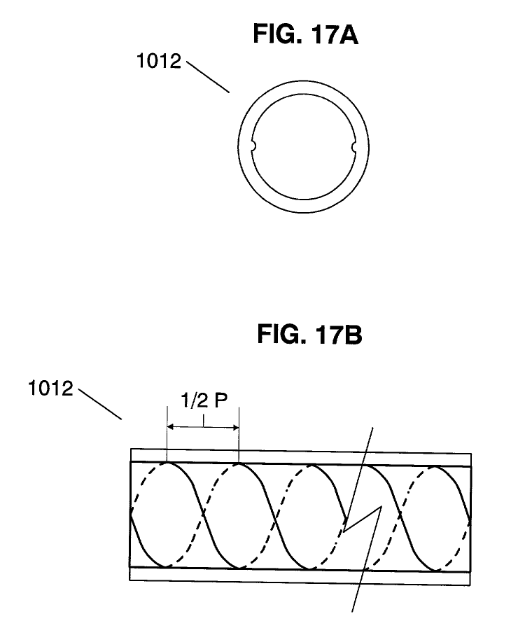

Referring now to FIGS. 17A-17B, a chiral fiber 1012 includes first and second helices of the desired double helix structure that are formed by a pair of grooves cut into sides of an optical fiber in a double helix pattern. The shape and size of the grooves may be selected as a matter of design choice without departing from the spirit of the invention. It should be noted that only a single helical groove pattern may be inscribed, as a matter of design choice, to produce a fiber grating with a single helix symmetry (not shown).

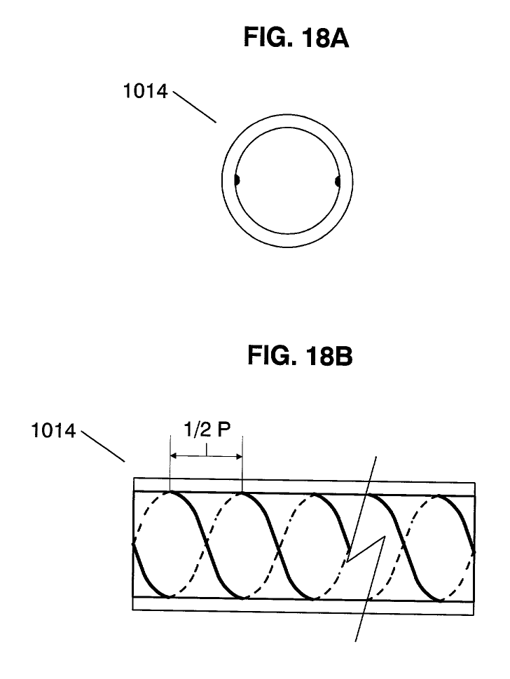

Referring now to FIGS. 18A-18B, a chiral fiber 1014 includes first and second helices of the desired double helix structure are formed by a pair of grooves cut into sides of the chiral fiber in a double helix pattern and filled with a dielectric material having different optical properties from the material of the fiber core. The shape and size of the grooves and the dielectric material may be selected as a matter of design choice without departing from the spirit of the invention. It should be noted that only a single helical pattern of a groove filled with the dielectric material may be formed, as a matter of design choice, to produce a fiber grating with a single helix symmetry (not shown).

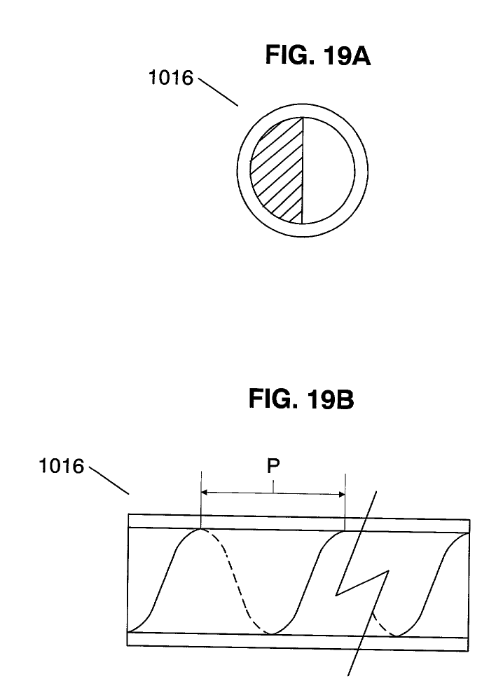

Referring now to FIGS. 19A-19B, a chiral fiber 1016 is composed of a first half-cylindrical portion of a first material parallel to a second half-cylindrical portion of a second material, where each of the first and second materials have different optical properties. The fiber 1016 is twisted around its longitudinal axis so that a single helix structure along the length of the fiber is formed from the two different materials. The specific materials used may be selected as a matter of design choice without departing from the spirit of the invention. While this arrangement does not form the desirable double helix structure (and thus does not mimic CLC properties), a chiral fiber having a single helix configuration is still useful in a number of applications requiring optically resonant materials.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. An apparatus for fabricating a fiber grating structure comprising:
an optical fiber having a central longitudinal axis; and
fabrication means for imposing refractive index modulation along the central longitudinal axis of said optical fiber in one of a first and second configuration, wherein in said first configuration said optical fiber is formed into a chiral structure having a first pitch and a period, wherein said first pitch is twice said period, and wherein in said second configuration said optical fiber is formed into a chiral structure having a second pitch and a period, wherein said second pitch is substantially equal to said period.

2. The fiber grating fabrication apparatus of claim 1, wherein said fabrication means comprises:
first process means for imposing said refractive index modulation in said first configuration as a double helical pattern comprising a first helix pattern having a predetermined pitch and a second helix pattern of said predetermined pitch along said longitudinal axis of said optical fiber, wherein said second helix is arranged one half of said predetermined pitch forward of said first helix along said central longitudinal axis.

3. The fiber grating fabrication apparatus of claim 1, wherein said fabrication means comprises:
second process means for imposing said refractive index modulation in said second configuration as a single helical pattern having said second pitch along said longitudinal axis of said optical fiber.

4. The fiber grating fabrication apparatus of claim 1, wherein said optical fiber is selected from a group consisting of: an optical fiber core and an optical fiber core enclosed by at least one cladding layer.

5. The fiber grating fabrication apparatus of claim 1, wherein said optical fiber comprises a first end and a second end, and wherein said fabrication means comprises:
a first process stage that retains said first end of said optical fiber;
a second process stage that retains said second end of said optical fiber; and
a third process stage, positioned between said first and said second process stages, that imposes said refractive index modulation in one of said first and second configurations on said optical fiber, between said first end and said second end, to form said optical fiber into a chiral fiber grating.

6. The fiber grating fabrication apparatus of claim 5, further comprising:
vibration control means for restricting lateral vibration of said optical fiber.

7. The fiber grating fabrication apparatus of claim 6, wherein said vibration control means comprises at least one aperture, sized to receive and retain said optical fiber while restricting lateral movement thereof, defined in at least one of said first, second, and third process stages.

8. The fiber grating fabrication apparatus of claim 6, wherein said vibration control means comprises at least one member each having an aperture, sized to receive and retain said optical fiber while restricting lateral movement thereof, said at least one member being positioned between at least two of said first, second, and third process stages.

9. The fiber grating fabrication apparatus of claim 5, wherein said second process stage further comprises a tensioning unit for providing constant tension to said second end of said fiber.

10. The fiber grating fabrication apparatus of claim 5, wherein said optical fiber is selected from a group consisting of:
an optical fiber core having a non-circular cross-section with 180 degree cross-sectional symmetry;
an optical fiber core having a non-circular cross-section with 180 degree cross-sectional symmetry enclosed in and in contact with a hollow cladding cylinder having an inner surface having filling material disposed in an empty area between said optical fiber core and said inner surface of said cladding cylinder, fiber core being composed of a first dielectric material and said filling material being composed from a second dielectric material, wherein said first and second dielectric materials are of different optical properties;
an optical fiber core having a single groove inscribed in its outer surface along said central longitudinal axis;
an optical fiber core having at least one pair of opposed grooves inscribed in its outer surface along said central longitudinal axis;
an optical fiber core composed of said first dielectric material having a single groove inscribed in its outer surface along said central longitudinal axis, wherein said groove is filled with said second dielectric material having optical properties that are different from said first dielectric material;
an optical fiber core composed of said first dielectric material having a pair of opposed grooves inscribed in its outer surface along said central longitudinal axis, wherein said pair of grooves are filled with said second dielectric material having optical properties that are different from said first dielectric material;
an optical fiber core composed of said first dielectric material having an elongated member, of a smaller diameter than said optical fiber core, composed of said second dielectric material positioned on its outer surface along said central longitudinal axis;
an optical fiber core composed of said first dielectric material having a pair of opposed elongated members, of a smaller diameter than said optical fiber core, composed of said second dielectric material positioned on its outer surface along said central longitudinal axis;
an optical fiber core comprising, clockwise, a first elongated quarter-cylindrical portion composed of said first dielectric material, a second elongated quarter-cylindrical portion composed of said second dielectric material, in contact with said first portion, a third elongated quarter-cylindrical portion composed of said first dielectric material in contact with said second portion, and a fourth elongated quarter-cylindrical portion composed of said second dielectric material in contact with said third and said first portions, said second dielectric material having different optical properties from said first dielectric material; and
an optical fiber core having a first elongated half-cylindrical portion composed of said first dielectric material and a second elongated half-cylindrical portion composed of a second dielectric material, said second dielectric material having different optical properties from said first dielectric material, and said first and second portions having their flat surfaces in contact with one another.

11. The fiber grating fabrication apparatus of claim 5, wherein one of said first and second process stages comprises:
first twisting means for twisting in a first direction at a first twisting speed and acceleration, during operation of said third process stage, said optical fiber by one of said first and said second ends while the other of said first and second ends is retained by the other of said first and second process stages.

12. The fiber grating fabrication apparatus of claim 11, wherein the other of said first and second process stages comprises:
second twisting means for twisting in a second direction at a second twisting speed and acceleration, during operation of said third process stage, said optical fiber by the other said first and said second ends while said one of said first and second ends is twisted by said first twisting means in said first direction.

13. The fiber grating fabrication apparatus of claim 12, wherein said first direction is radially opposite to said second direction.

14. The fiber grating fabrication apparatus of claim 12, wherein said first twisting speed and acceleration is one of:
the same as said second twisting speed and acceleration, and different from said second twisting speed and acceleration.

15. The fiber grating fabrication apparatus of claim 11, wherein said third process stage comprises:
a heater for heating a portion of said optical fiber to a predefined process temperature, said process temperature being sufficient to cause said optical fiber to be susceptible to twisting.

16. The fiber grating fabrication apparatus of claim 15, wherein said heater comprises:
a heat source for generating heat;
a conductor for conducting heat generated by said heat source to a predefined area of said heater such that heat is applied to said optical fiber in an heating area only sufficient to enable said optical fiber to be twisted at said area, when said area is heated to said process temperature.

17. The fiber grating fabrication apparatus of claim 16, wherein said heater further comprises:
a temperature control medium for restricting propagation of heat along said optical fiber outside said heating area.

18. The fiber grating fabrication apparatus of claim 17, wherein said temperature control medium comprises at least one of insulation medium and an active cooler.

19. The fiber grating fabrication apparatus of claim 16, further comprising first linear translation means for moving at least one of said first, second and third process stages relative to one another at a first translation speed and acceleration such that said optical fiber is moved through said heater while said optical fiber is being twisted.

20. The fiber grating fabrication apparatus of claim 19, wherein said first linear translation means moves said at least one of said first, second and third process stages relative to one another such that both said first and second ends of said optical fiber are moved at said first translation speed and acceleration.

21. The fiber grating fabrication apparatus of claim 19, wherein said first linear translation means moves said at least one of said first, second and third process stages relative to one another such that a first portion of said optical fiber that has not passed through said heater is moved at said first translation speed and acceleration and a second portion of said optical fiber that has passed through said heater and has been twisted is moved at a second translation speed and acceleration, higher that said first translation speed and acceleration, thereby reducing a diameter of said second portion of said optical fiber, such that said resulting chiral fiber grating is of a lesser diameter than said optical fiber.

22. The fiber grating fabrication apparatus of claim 19, further comprising a control unit, connected to said first, second, and third process stages, operable to automatically control operation thereof to produce a chiral fiber grating from an optical fiber.

23. The fiber grating fabrication apparatus of claim 19, wherein said control unit is connected to said first linear translation means, and is operable to control:
said first and second twisting direction;
said first twisting speed and acceleration;
said second twisting speed and acceleration;
said process temperature;
said first translation speed and acceleration; and
said second translation speed and acceleration.

24. The fiber grating fabrication apparatus of claim 23, further comprising monitoring means, connected to said control unit, for monitoring optical characteristics of said chiral fiber grating during operation of said first, second and third process stages to determine whether said produced chiral fiber grating is meeting predetermined fabrication requirements.

25. The fiber grating fabrication apparatus of claim 24, wherein when said monitoring means determines that said chiral fiber grating does not substantially satisfy said predetermined fabrication requirements, said control unit is operable to:
determine which parameter of the group consisting of: said first and second twisting direction, said first and second twisting speed and respective acceleration, said process temperature, and said first and second translation speed and respective acceleration, is causing deviation from said predetermined fabrication requirements, and
change at least one of said parameters until said monitoring means determines that said predetermined fabrication requirements have been substantially satisfied.

26. The fiber grating fabrication apparatus of claim 19, wherein said control unit is operable to selectively control at least one of said first and second twisting speed and respective acceleration and said first and second translation speed and respective acceleration to produce a modified chiral fiber grating selected from a group consisting of:
a chirped chiral fiber grating having a period that varies along said central longitudinal axis.
an apodized chiral fiber grating having a first section, a sequential second section of a constant grating strength, and a sequential third section, wherein said first section comprises increasing grating strength, and said third section comprises decreasing grating strength; and
a distributed chiral twist fiber grating having a first section of a first pitch, a second section of a second pitch, and a third section of said first pitch, wherein said second section comprises a distributed chiral twist of a predetermined angle between said first and said third sections.

27. The fiber grating fabrication apparatus of claim 22, further comprising a feeding unit for feeding a predetermined length of said optical fiber through one of said first and second process stages until said optical fiber is secured at both said first and second process stages.

28. The fiber grating fabrication apparatus of claim 27, wherein said feeding unit further comprises cutting means for cutting said optical fiber after said optical fiber has been secured.

29. The fiber grating fabrication apparatus of claim 27, wherein said feeding unit further comprises a fiber preparation unit for preparing an optical fiber to receive said refractive index modulation.

30. The fiber grating fabrication apparatus of claim 29, wherein said fiber preparation unit further comprises one of:
machining means for inscribing at least one groove in an outer surface of said optical fiber along said central longitudinal axis, wherein when two grooves are inscribed, each of said two grooves is positioned opposite to one another on said outer surface; and
fiber shaping means for shaping said optical fiber into a shaped optical fiber core having a non-circular cross-section with 180 degree cross-sectional symmetry.

31. The fiber grating fabrication apparatus of claim 30, wherein said fiber shaping means comprises a heater for heating said optical fiber and a shaped drawing device for drawing said optical fiber into said shaped optical fiber core.

32. The fiber grating fabrication apparatus of claim 29, wherein said control unit is connected to at least one of said feeding unit, said cutting unit, and said fiber preparation unit, and is operable to control operation thereof.

33. The fiber grating fabrication apparatus of claim 32, wherein said control unit is operable to:
automatically activate said feeding unit to feed another predetermined length of an additional optical fiber through one of said first and second process stages;
activate said cutting means to cut said additional optical fiber after said additional optical fiber has been secured at both said first and second process stages, after said predetermined length of said optical fiber has passed through said first, second and third process stages and has been formed into said chiral fiber grating; and
activate said first, second and third process stages to form an additional chiral fiber grating from said additional optical fiber.

34. The fiber grating fabrication apparatus of claim 24, further comprising adjustment means, connected to said monitoring means, for adjusting optical characteristics of said chiral fiber grating after said fiber grating exits said first, second and third process stages, when said monitoring means determines that said produced chiral fiber grating has not met said predetermined fabrication requirements.

35. The fiber grating fabrication apparatus of claim 34, wherein said adjustment means comprise at least one fiber grating modification device selected from a group consisting of:
secondary twisting means for applying additional twists to said produced chiral fiber grating; and
drawing means for changing a length of said produced chiral fiber grating.

36. The fiber grating fabrication apparatus of claim 22, further comprising an annealing unit for heating, to an annealing temperature, and then slowly cooling said fiber grating after said fiber grating exits said first, second and third process stages to thereby reduce stress in said fiber grating.

37. The fiber grating fabrication apparatus of claim 22, further comprising a cladding application unit for applying, when said fiber grating is formed from an unclad optical fiber, at least one layer of cladding to said fiber grating after said fiber grating exits said first, second and third process stages.

38. The fiber grating fabrication apparatus of claim 22, further comprising a collection unit for collecting and storing at least one fiber grating after each of said at least one fiber grating exits said first, second and third process stages.

39. The fiber grating fabrication apparatus of claim 12, wherein said first direction is the same as said second direction, further comprising:
second linear translation means for moving at least one of said third process stage and both said first and second process stages relative to one another at a third linear translation speed and acceleration, such that a substantial portion of said optical fiber passes through said third process stage

40. The fiber grating fabrication apparatus of claim 39, wherein said third process stage comprises:
a machining unit that inscribes at least one helical groove of a predefined pitch in an outer surface of said optical fiber along said central longitudinal axis, wherein when two helical grooves are inscribed, each of said two grooves is positioned opposite to one another on said outer surface such that a second helical groove of said two grooves is shifted forward from a first helical groove of said two grooves by substantially one half of said predefined pitch.

41. The fiber grating fabrication apparatus of claim 40, further comprising a first process control unit operable to selectively control at least one of said first and second twisting speed and respective acceleration and said third translation speed and acceleration to produce a modified chiral fiber grating selected from a group consisting of:
a chirped chiral fiber grating having a period that varies along said central longitudinal axis;
an apodized chiral fiber grating having a first section, a sequential second section of a constant grating strength, and a sequential third section, wherein said first section comprises increasing grating strength, and said third section comprises decreasing grating strength; and
a distributed chiral twist fiber grating having a first section of a first pitch, a second section of a second pitch, and a third section of said first pitch, wherein said second section comprises a distributed chiral twist of a predetermined angle between said first and said third sections.

42. The fiber grating fabrication apparatus of claim 40, further comprising second monitoring means for monitoring optical characteristics of said chiral fiber grating during operation of said first, second and third process stages to determine whether said produced chiral fiber grating is meeting predetermined fabrication requirements.

43. The fiber grating fabrication apparatus of claim 42, further comprising second adjustment means, connected to said second monitoring means, for adjusting optical characteristics of said chiral fiber grating after said fiber grating exits said first, second and third process stages, when said second monitoring means determines that said produced chiral fiber grating has not met said predetermined fabrication requirements.

44. The fiber grating fabrication apparatus of claim 40, further comprising a second annealing unit for heating, to an annealing temperature, and then slowly cooling said fiber grating after said fiber grating exits said first, second and third process stages.

45. The fiber grating fabrication apparatus of claim 40, further comprising a second cladding application unit for applying, when said fiber grating is formed from an unclad optical fiber, at least one layer of cladding to said fiber grating after said fiber grating exits said first, second and third process stages.

46. The fiber grating fabrication apparatus of claim 40, further comprising a second collection unit for collecting and storing at least one fiber grating after each of said at least one fiber grating exits said first, second and third process stages.

47. The fiber grating fabrication apparatus of claim 39, wherein said third process stage comprises:
a wrapping unit that wraps at least one fiber element composed of a different dielectric material from said optical fiber and having a diameter less than said optical fiber, in a helical pattern of a second predefined pitch around said outer surface of said optical fiber along said central longitudinal axis, wherein when two fiber elements are wrapped, a second helical pattern formed by the second of said two fiber elements is shifted forward from a first helical pattern of the first of said two fiber elements by substantially one half of said second predefined pitch.

48. The fiber grating fabrication apparatus of claim 47, further comprising a second process control unit operable to selectively control at least one of said first and second twisting speed and respective acceleration and said third translation speed and acceleration to produce a modified chiral fiber grating selected from a group consisting of:
a chirped chiral fiber grating having a period that varies along said central longitudinal axis;
an apodized chiral fiber grating having a first section, a sequential second section of a constant grating strength, and a sequential third section, wherein said first section comprises increasing grating strength, and said third section comprises decreasing grating strength; and
a distributed chiral twist fiber grating having a first section of a first pitch, a second section of a second pitch, and a third section of said first pitch, wherein said second section comprises a distributed chiral twist of a predetermined angle between said first and said third sections.

49. The fiber grating fabrication apparatus of claim 47, further comprising third monitoring means for monitoring optical characteristics of said chiral fiber grating during operation of said first, second and third process stages to determine whether said produced chiral fiber grating is meeting predetermined fabrication requirements.

50. The fiber grating fabrication apparatus of claim 49, further comprising third adjustment means, connected to said third monitoring means, for adjusting optical characteristics of said chiral fiber grating after said fiber grating exits said first, second and third process stages, when said third monitoring means determines that said produced chiral fiber grating has not met said predetermined fabrication requirements.

51. The fiber grating fabrication apparatus of claim 47, further comprising a third annealing unit for heating, to an annealing temperature, and then slowly cooling said fiber grating after said fiber grating exits said first, second and third process stages.

52. The fiber grating fabrication apparatus of claim 47, further comprising a third cladding application unit for applying, when said fiber grating is formed from an unclad optical fiber, at least one layer of cladding to said fiber grating after said fiber grating exits said first, second and third process stages.

53. The fiber grating fabrication apparatus of claim 47, further comprising a third collection unit for collecting and storing at least one fiber grating after each of said at least one fiber grating exits said first, second and third process stages.

54. A method for fabricating a fiber grating structure from an optical fiber having a central longitudinal axis, comprising the step of:
(a) imposing refractive index modulation along the central longitudinal axis of said optical fiber in one of a first and second configuration, wherein in said first configuration said optical fiber is formed into a chiral structure having a first pitch and a period, wherein said first pitch is twice said period, and wherein in said second configuration said optical fiber is formed into a chiral structure having a second pitch and a period, wherein said second pitch is substantially equal to said period.

55. The fabrication method of claim 54, wherein the optical fiber comprises a first end and a second end, and wherein said step (a) comprises the steps of:
(b) retaining said first end of said optical fiber;
(c) retaining said second end of said optical fiber;
(d) imposing said refractive index modulation in one of said first and second configurations on said optical fiber, between said first end and said second end, to form said optical fiber into a chiral fiber grating.
